(19) United States
(12) Patent Application Publication
(10) Pub. No.: US 2025/0193138 A1
(43) Pub. Date: Jun. 12, 2025

(54) SYSTEM AND METHOD FOR SHARING USER COMMUNICATION STATUS WITH INDIVIDUALS

(71) Applicants: SAI RAJ SHIRIDI KONDOGI, Leander, TX (US); MEGHA KONDOGI, Leander, TX (US); SAI VARUN KONDOGI, Leander, TX (US)

(72) Inventors: SAI RAJ SHIRIDI KONDOGI, Leander, TX (US); MEGHA KONDOGI, Leander, TX (US); SAI VARUN KONDOGI, Leander, TX (US)

(21) Appl. No.: 18/966,346

(22) Filed: Dec. 3, 2024

Related U.S. Application Data
(60) Provisional application No. 63/606,690, filed on Dec. 6, 2023.

(51) Int. Cl. H04L 51/043; H04L 51/046; H04L 51/224; H04L 51/52

(52) U.S. Cl. CPC H04L 51/043; H04L 51/046; H04L 51/224; H04L 51/52

(57) ABSTRACT

Exemplary embodiments of the present disclosure are directed towards a system and method for sharing user communication status with individuals, comprising a first computing device with a communication status sharing module that enables users to register, authenticate, and send friend requests to connect with trusted contacts. Friend requests are transmitted to a server, which processes and forwards them to the computing devices of potential contacts. Upon acceptance, the system displays user profiles and real-time communication statuses using predefined indicators: green (free to talk), red (busy), and purple (free to text). The communication status sharing module allows users to manually update their statuses, which are transmitted to the server and shared only with directly connected users, ensuring privacy. Additionally, the system facilitates initiating communication actions, such as calls, messages, or in-app chats, based on the real-time statuses of connected users, promoting seamless, efficient, and informed communication within a trusted network.

### CROSS-REFERENCE TO RELATED APPLICATIONS

This patent application claims priority benefit of U.S. Provisional Patent Application No. 63/606,690, entitled “SYSTEM AND METHOD FOR SHARING USER COMMUNICATION STATUS WITH INDIVIDUALS”, filed on 6 Dec. 2023. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to digital communication systems and mobile applications. More particularly, the present disclosure relates to a system and method for sharing user communication status with individuals.

### BACKGROUND

In today's digital age, communication plays a fundamental role in the daily lives of individuals. The proliferation of mobile devices and messaging applications has revolutionized the way people connect with one another. However, this abundance of communication options has introduced a new challenge—the ability to efficiently determine the availability and willingness of friends and contacts to engage in real-time conversations.

In many social circles, individuals typically maintain close relationships with a select group of three to five friends, each of whom holds a special place in their lives. However, despite the close bond that exists between these friends, there is an inherent challenge that often arises. When the need for a conversation or connection arises, the individual is faced with a dilemma-how to ascertain the availability and willingness of these close friends to engage in communication. Traditionally, this involves a time-consuming and often intrusive process where the individual must reach out to each friend individually, either through phone calls or messages, inquiring, “Are you free to talk?” This cumbersome and inefficient approach can disrupt not only the individual's activities but also their friends, leading to a significant communication challenge that needs a more streamlined and considerate solution.

The existing conventional messaging applications and social media platforms primarily focus on the number of connections rather than the quality of interactions, leading to cluttered interfaces, excessive notifications, and the blurring of lines between personal and professional relationships. This confluence of platforms can result in miscommunication and hinder the genuine, meaningful interaction that close friends seek. As a result, users frequently experience the frustration of not knowing whether a friend is available for a phone call or prefers to communicate through text messages. This lack of clarity can lead to unnecessary disruptions, missed opportunities for meaningful conversations, and wasted time. There is a need for a systematic and user-friendly solution that addresses this technical problem by enabling individuals to share their communication status in real time, facilitating seamless and informed communication choices.

In the light of the aforementioned discussion, there exists a need for a system with novel methodologies that would overcome the above-mentioned challenges.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for sharing user communication status with individuals.

An objective of the present disclosure is directed towards allowing a user to manually update his real-time communication status, represented by the colors green (free to talk), red (busy with work), and purple (free to text).

Another objective of the present disclosure is directed towards a system that automatically changes the user status to the purple color if the user forgets to update their status after 24 hours, indicating they are free to text.

Another objective of the present disclosure is directed towards a system that enables the user to add two or more close friends from their contacts, and an authentication process ensures that the friends accept or decline the invitation. Once connected, users can view the real-time communication status of their friends and choose from voice calls, text messages, or in-app chat based on their friends' availability.

Another objective of the present disclosure is directed towards a system that facilitates communication by allowing users to check their friends' statuses and choose between calling, talking, or chatting based on the friends' availability.

Another objective of the present disclosure is directed towards providing a two-way signaling system that updates friends' statuses (green, red, and purple) based on friends' inputs and constantly checks for status updates within the close group of friends.

Another objective of the present disclosure is directed towards a system that never blocks the user from calling or texting friends, even if the friends' status is red (indicating they are busy).

Another objective of the present disclosure is directed towards a system that provides a user-friendly design with two rows and columns and various design elements, including circles, clouds, bubbles, arrows, flashlights, blinking colors, neon colors, and lights.

Another objective of the present disclosure is directed towards a system that enables the user to block specific friends by clicking the friend name.

Another objective of the present disclosure is directed towards a system that changes the user status to purple color for blocked friends, indicating that the user is available for text but not calls.

Another objective of the present disclosure is directed towards a system that enables the user to maintain close, personal connections and the system encourages meaningful interactions with a limited group of friends.

Another objective of the present disclosure is directed towards a system that enables the user to instantly gauge their friends' availability for different communication methods.

Another objective of the present disclosure is directed towards a system that enables the user to selectively share their communication status with trusted individuals (friends), ensuring privacy while maintaining open lines of communication.

Another objective of the present disclosure is directed towards simplifying the process of updating and checking friends' communication statuses in real-time.

Another objective of the present disclosure is directed towards a system that displays warning messages to prevent disruptions when contacting busy friends.

Another objective of the present disclosure is directed towards a system that saves the user time by providing instant insights into their friends' availability, eliminating the need for manual status inquiries.

Another objective of the present disclosure is directed towards a system that enables the user to choose the most suitable communication method, whether calling, talking, or texting, based on their friends' real-time statuses.

Another objective of the present disclosure is directed towards a system that enables the user to integrate the system with the user's preferred messaging applications, such as WhatsApp, iMessages, Telegram, Signal, and WeChat, for seamless communication.

Another objective of the present disclosure is directed towards a system that easily integrates with various technologies, including Bluetooth, OTP (One-Time Passcode), mobile authenticators, Sonar, Lidar, Magnetic Ink, Radar Technologies, QR Codes, Bar Codes, Captcha, and more.

Another objective of the present disclosure is directed towards a system that easily integrates with Peoplesoft, SAP, SuccessFactors, Salesforce, and Cerner.

According to an exemplary aspect of the present disclosure, a first computing device comprising a processor for executing instructions from a communication status sharing module located within the computing device, wherein the communication status sharing module is configured to enable a first user to register and authenticate on the communication status sharing module, enabling the first user to send friend requests to connect with a second user, a third user, an nth user, and additional trusted contacts, thereby the communication status sharing module transmitting the friend requests to a server over a network.

According to another exemplary aspect of the present disclosure, the server configured to receive the friend requests from the communication status sharing module and, whereby the server comprises a communication status processing module configured to transmit the friend requests to the computing devices of the second user, third user, nth user, and additional trusted contacts over the network, wherein the computing devices of the second user, third user, nth user, and additional trusted contacts are configured to display the received friend requests through the communication status sharing module and allow the respective users to accept or reject the friend requests, thereby the communication status processing module processes the data and displays the user's profile and communication status of connected users to the first user on the first computing device upon accepting the friend requests.

According to another exemplary aspect of the present disclosure, the communication status sharing module configured to enable the first user, second user, third user, nth user, and additional trusted contacts to manually set and update their real-time communication status using predefined indicators, including green (free to talk), red (busy), and purple (free to text), thereby the communication status sharing module transmitting the first user, second user, third user, nth user, and additional trusted contacts selected statuses to the server over the network.

According to another exemplary aspect of the present disclosure, the communication status processing module configured to receive the communication statuses of the first user, second user, third user, nth user, and additional trusted contacts from the communication status sharing module, thereby the communication status processing module processes the communication statuses and transmits the updated statuses only to the respective computing devices of directly connected users over the network, wherein the communication status sharing module is configured to display the real-time statuses of connected users only to those users who share a direct connection, ensuring that each user can view and interact based on the current availability of their directly connected contacts.

According to another exemplary aspect of the present disclosure, the communication status sharing module is configured to enable the first user, second user, third user, and nth user to initiate communication actions, including making calls, sending messages, or engaging in in-app chats, based on the real-time communication statuses of their connected users.

### BRIEF DESCRIPTION OF THE DRAWINGS

FIG. 1 is a block diagram depicting a schematic representation of a system for sharing user communication status with individuals, in accordance with one or more exemplary embodiments.

FIG. 2 is a block diagram depicting an embodiment of the communication status sharing module 114 on the computing devices, in accordance with one or more exemplary embodiments.

FIG. 3 is a block diagram depicting an embodiment of the communication status processing module 116 on the server, in accordance with one or more exemplary embodiments.

FIGS. 4A, 4B, and 4C are example screens depicting embodiments of the user interface module, in accordance with one or more exemplary embodiments.

FIG. 5A is an example screen depicting a user interface of the communication status sharing module, showcasing the introduction page for the system, in accordance with one or more exemplary embodiments.

FIGS. 5B and 5C are example screens depicting an interface of the communication status sharing module, showcasing the availability and active status feature of the system, in accordance with one or more exemplary embodiments.

FIG. 5D is an example screen depicting an interface of the communication status sharing module, showcasing the user registration process, in accordance with one or more exemplary embodiments.

FIG. 5E is an example screen depicting an interface of the communication status sharing module, showcasing the phone number verification process using an OTP (One-Time Passcode), in accordance with one or more exemplary embodiments.

FIGS. 5F, 5G, and 5H are example screens depicting an interface of the communication status sharing module, showcasing the user's communication dashboard where friends' statuses are visually represented in accordance with one or more exemplary embodiments.

FIG. 5I is an example screen depicting the interface of the communication status sharing module during an ongoing video call, showcasing options for interacting with the friend, in accordance with one or more exemplary embodiments.

FIG. 5J is an example screen depicting the interface of the communication status sharing module, showcasing the option to share an invitation to the user's contacts, in accordance with one or more exemplary embodiments.

FIG. 5K is an example screen depicting the interface of the communication status sharing module, showcasing the account management and settings menu, in accordance with one or more exemplary embodiments.

FIG. 6 is a flow diagram depicting a method for user registration on the communication status sharing module 114, in accordance with one or more exemplary embodiments.

FIG. 7 is a flow diagram depicting a method for updating user communication status on the communication status sharing module 114, in accordance with one or more exemplary embodiments.

FIG. 8 is a flow diagram depicting a method for method for sharing user communication statuses with individuals, in accordance with one or more exemplary embodiments.

FIG. 9 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and so forth, herein do not denote any order, quantity, or importance, but rather are used to distinguish one element from another.

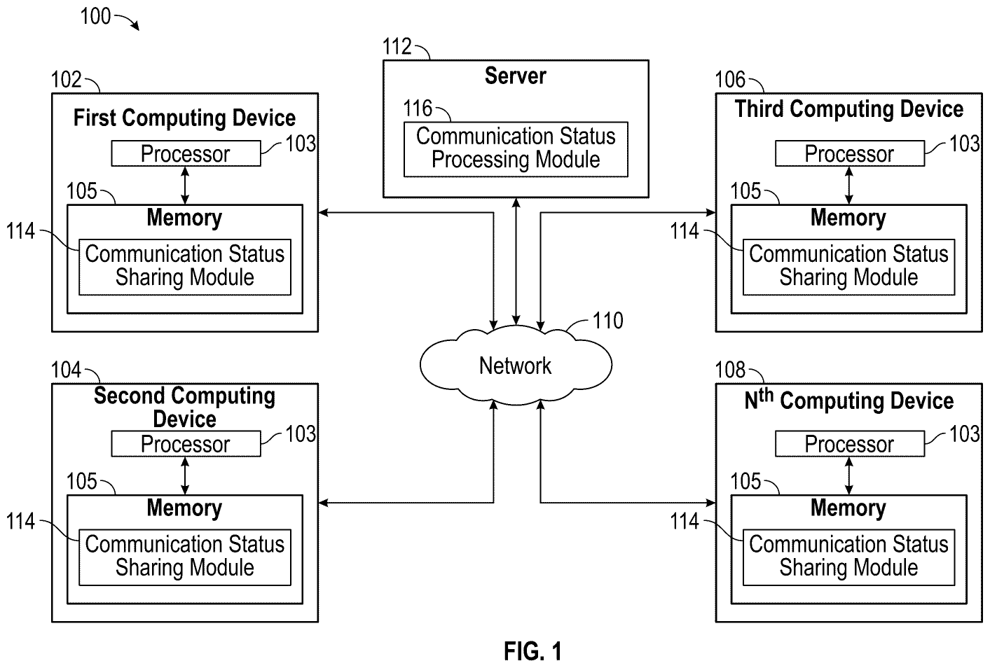

Referring to FIG. 1 is a block diagram 100 depicting a schematic representation of a system for sharing user communication status with individuals, in accordance with one or more exemplary embodiments. The system 100 includes a first computing device 102, a processor 103, a second computing device 104, a memory 105, a third computing device 106, an N^{th} computing device 108, a network 110, a server 112, a communication status sharing module 114, and a communication status processing module 116.

The first computing device 102 may include a first user device. The first user may include but not limited to individuals, normal users, students, businessman, teachers, professors, doctors, and the like. The second computing device 104 may include a second user device. The second user may be the first user's friend. The third computing device 106 may include a third user device. The third user may be the first user's friend. The N^{th} computing device may include the N^{th} user device. The N^{th} user may be the first user's friend. The computing devices 102, 104, 106, and 108 may include a processor 103 configured to execute instructions and a memory 105 configured to store the communication status sharing module 114. The computing devices 102, 104, 106, and 108 may include the processor 103 in communication with a memory 105. The processor 103 may be a central processing unit. The memory 105 is a combination of flash memory and random-access memory. The processor 103 may execute instructions and process data within the system. The computing devices 102, 104, 106, and 108 may include but are not limited to, a personal digital assistant, smartphones, personal computers, a mobile station, computing tablets, a handheld device, an internet-enabled calling device, an internet enabled calling software, a telephone, a mobile phone, a digital processing system, and so forth. The computing devices 102, 104, 106, and 108 may include the processor 103. The processor 103 may include but is not limited to, a general-purpose processor, a microcontroller, a digital signal processor (DSP), an application-specific integrated circuit (ASIC), a graphics processing unit (GPU), a field-programmable gate array (FPGA), or a system on a chip (SoC). The processor 103 may be configured to execute instructions stored in the memory 105 and to perform various operations associated with the communication status sharing module 114. These operations may include processing user inputs, updating communication statuses, managing data exchanges with the server 112, and facilitating the user interface functionality. The computing devices 102, 104, 106, and 108 may include the memory 105. The memory 105 may include any suitable type of non-volatile or volatile storage medium, such as random-access memory (RAM), read-only memory (ROM), flash memory, solid-state drives (SSD), or hard disk drives (HDD). The memory 105 may be configured to store the communication status sharing module 114, user credentials, communication status data, application preferences, and other relevant information. The memory 105 enables the seamless operation of the module by storing intermediate and final states of user data, application logic, and any real-time updates received from the server 112.

The computing devices 102, 104, 106, and 108 may be communicatively connected to the server 112 over the network 110. The network 110 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing devices 102, 104, 106, and 108 are shown in FIG. 1, an embodiment of the system 100 may support any number of computing devices. The computing devices 102, 104, 106, and 108 may be operated by the users. The computing devices 102, 104, 106, and 108 supported by the system 100 is realized as a computer-implemented or computer-based device having the hardware or firmware, software, and/or processing logic needed to carry out the computer-implemented methodologies described in more detail herein.

The computing devices 102, 104, 106, and 108 may include the communication status sharing module 114. The communication status sharing module 114 may be any suitable applications downloaded from GOOGLE PLAY® (for Google Android devices), Apple Inc.'s APP STORE® (for Apple devices), or any other suitable database. The communication status sharing module 114 may be a desktop application which runs on Windows or Linux or any other operating system and may be downloaded from a webpage or a CD/USB stick etc. In some embodiments, the communication status sharing module 114 may be software, firmware, or hardware that is integrated into the computing devices 102, 104, 106, and 108. The computing devices 102, 104, 106, and 108 may present a web page to the user by way of a browser, wherein the webpage comprises a hyper-link may direct the user to uniform resource locator (URL).

The communication status sharing module 114 may be configured to enable the first user, second user, third user, and N^{th} user to update real time communication status on their respective computing devices. The communication status may be represented by the colors green (free to talk), red (busy with work), and purple (free to text). The communication status sharing module 114 may be configured to enable the first user, second user, third user, and N^{th} user to have control of their communication status by sharing this information selectively with trusted individuals. The communication status sharing module 114 may be configured to enable the first user, second user, third user, and N^{th} user to choose their preferred communication method, whether calling, talking, or texting. The communication status sharing module 114 may be configured to enable the first user, second user, third user, and N^{th} user to add up to 10 of their closest friends, who must accept an authentication request to establish a connection. once connected, the users can view the real-time communication status of their friends and choose from voice calls, text messages, or in-app chat based on their friends' availability.

In accordance with one or more exemplary embodiments of the present disclosure, the first computing device 102 may include the processor 103. The processor 103 may be configured to execute instructions from the communication status sharing module 114 located within the computing device. The communication status sharing module 114 may be configured to enable a first user to register and authenticate on the communication status sharing module 114, enabling the first user to send friend requests to connect with a second user, a third user, an nth user, and additional trusted contacts, thereby the communication status sharing module 114 transmitting the friend requests to a server over a network. The server 112 may be configured to receive the friend requests from the communication status sharing module 114. The server may include the communication status processing module 116 may be configured to transmit the friend requests to the computing devices 104, 106, and 108 of the second user, third user, nth user, and additional trusted contacts over the network 110. The computing devices 104, 106, and 108 of the second user, third user, nth user, and additional trusted contacts are configured to display the received friend requests through the communication status sharing module 114 and allow the respective users to accept or reject the friend requests, thereby the communication status processing module processes the data and displays the user's profile and communication status of connected users to the first user on the first computing device upon accepting the friend requests. The communication status sharing module 116 may be configured to enable the first user, second user, third user, nth user, and additional trusted contacts to manually set and update their real-time communication status using predefined indicators, including green (free to talk), red (busy), and purple (free to text), thereby the communication status sharing module 116 transmitting the first user, second user, third user, nth user, and additional trusted contacts selected statuses to the server over the network 110. The communication status processing module 116 may be configured to receive the communication statuses of the first user, second user, third user, nth user, and additional trusted contacts from the communication status sharing module, thereby the communication status processing module 116 processes the communication statuses and transmits the updated statuses only to the respective computing devices of directly connected users over the network 110. The communication status sharing module 114 may be configured to display the real-time statuses of connected users only to those users who share a direct connection, ensuring that each user can view and interact based on the current availability of their directly connected contacts. The communication status sharing module 114 may be configured to enable the first user, second user, third user, and nth user to initiate communication actions, including making calls, sending messages, or engaging in in-app chats, based on the real-time communication statuses of their connected users.

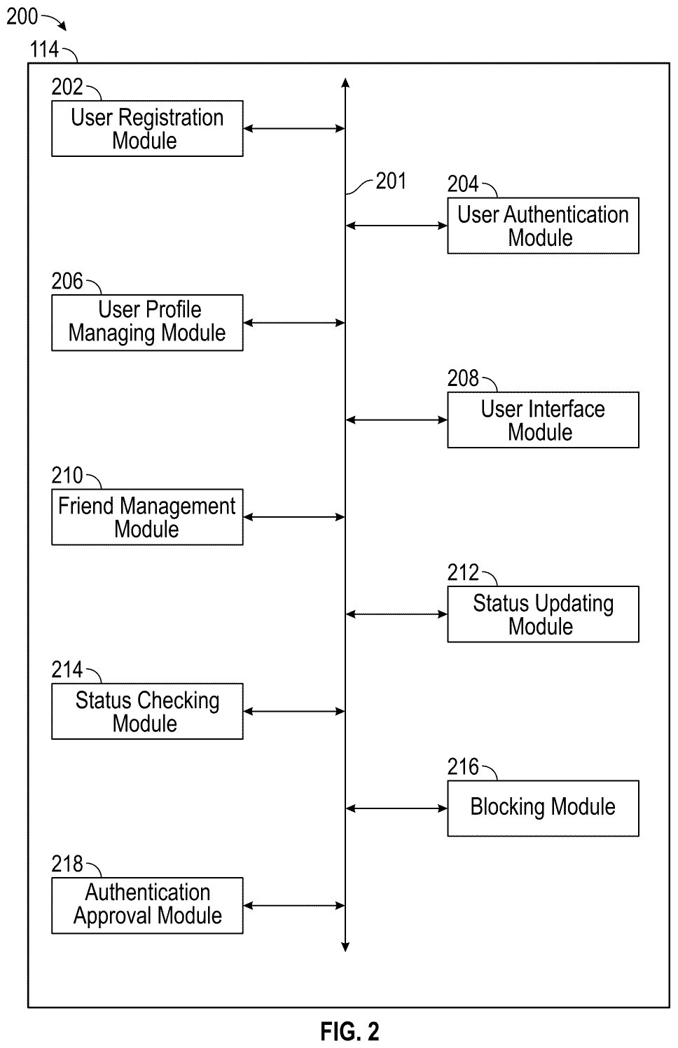

Referring to FIG. 2 is a block diagram 200 depicting an embodiment of the communication status sharing module 114 on the computing devices, in accordance with one or more exemplary embodiments. The communication status sharing module 114 includes a bus 201, a user registration module 202, a user authentication module 204, a user profile managing module 206, a user interface module 208, a friend management module 210, a status updating module 212, a status checking module 214, a blocking module 216, and an authentication approval module 218. The bus 201a may include a path that permits communication among the modules of the communication status sharing module 114 installed on the computing devices. The term “module” is used broadly herein and refers generally to a program resident in the memory 105 of the computing devices.

The user registration module 202 may be configured to enable the first user to register on the communication status sharing module 114 installed on the first computing device 102 by providing basic details of the first user. The basic details may include but are not limited to email, password, first and last name, phone number, address details, and the like. The user registration module 202 may be configured to transfer the first user registration details to server 112 over network 110. The server 112 may include the communication status processing module 116. The communication status processing module 116 may be configured to receive the user registration details from the user registration module 202. The user authentication module 204 may be configured to enable the first user to log in and access the communication status sharing module 114 installed on the first computing device 102 by using the first user login identity credentials. The user profile managing module 206 may be configured to enable the first user to set up and manage the user profile, which may include a profile picture, display name, and status message. The user profile managing module 206 may be configured to enable the first user to link the first user preferred messaging applications (e.g., WhatsApp, iMessages, Telegram, Signal, WeChat) to the communication status sharing module 114. The friend management module 210 may be configured to enable the first user to send friend requests to his contacts. The friend management module 210 may be configured to enable the first user to add two or more close friends from the first user's contacts. The friend management module 210 may be configured to transfer the friend requests to the server 112 over the network 110. The user interface module 208 may be configured to allow the users to see one or more friends' statuses. The status updating module 212 may be configured to enable the first users to manually set the real-time communication status by choosing a color. The status options may include green color (indicating availability for voice calls), red color (indicating busyness and unavailability for voice calls), and purple color (indicating availability for text-based communication). The status checking module 214 may be configured to allow users to view the statuses of their friends. The blocking module 216 may be configured to enable the users to block specific friends, changing their status to purple for that friend. The authentication approval module 218 may be configured to manage the authentication process for inviting friends and their acceptance or decline.

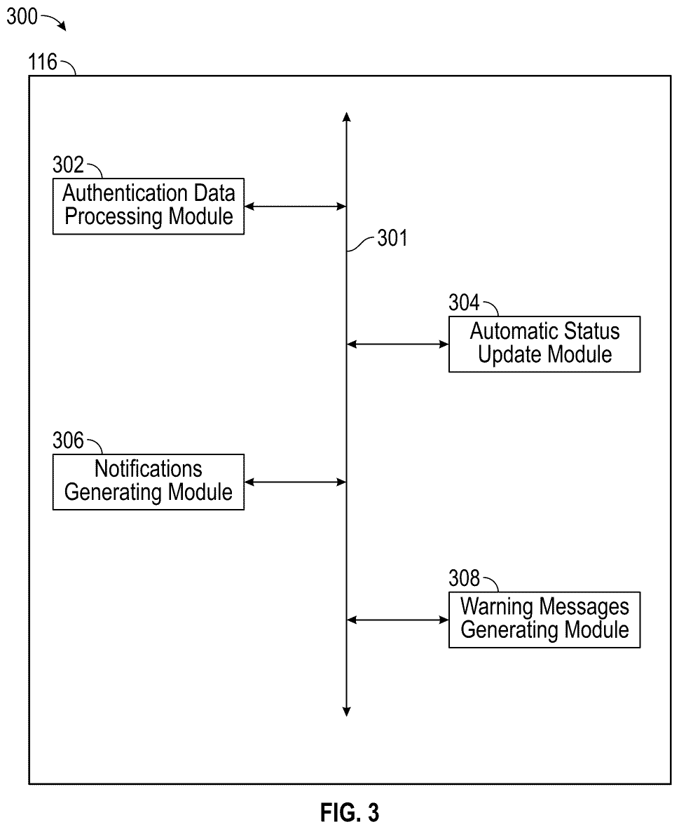

Referring to FIG. 3 is a block diagram 300 depicting an embodiment of the communication status processing module 116 on the server, in accordance with one or more exemplary embodiments, communication status processing module 116 includes a bus 301, an authentication data processing module 302, an automatic status update module 304, a notifications generating module 306, and a warning messages generating module 308. The bus 301 may include a path that permits communication among the modules of the communication status processing module 116 enabled on the sever 112.

The authentication data processing module 302 may be configured to receive the friend requests from the friend management module 210. The authentication data processing module 302 may be configured to send the friend requests to the friends' computing devices. The friends may include but not be limited to the second user, third user, N^{th}, and the like. The authentication data processing module 302 may be configured to receive the user registration details from the user registration module 202. The authentication data processing module 302 may also be configured to generate the user login identity credentials using the user registration details. The identity credentials comprise a unique identifier (e.g., a username, an email address, a date of birth, a house address, a mobile number, and the like), and a secured code (e.g., a password, a symmetric encryption key, biometric values, a passphrase, and the like). The automatic status update module 304 may be configured to automatically update the user statuses to purple when the user forgets to update the status even after 24 hours. The notifications generating module 306 may be configured to generate notifications for users regarding friend requests, status updates, and communication requests. The warning messages generating module 308 may be configured to generate the warning messages to prevent disruptions when contacting busy friends.

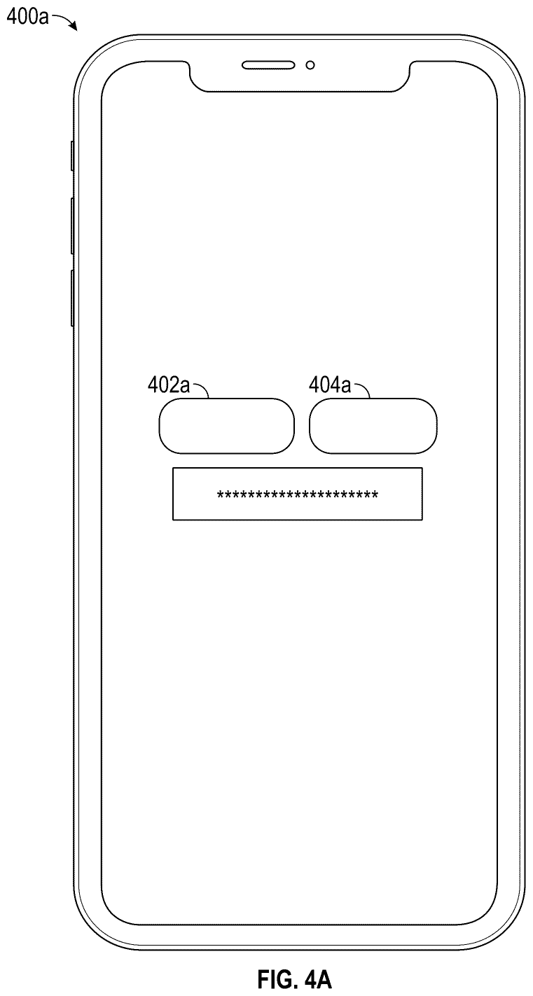

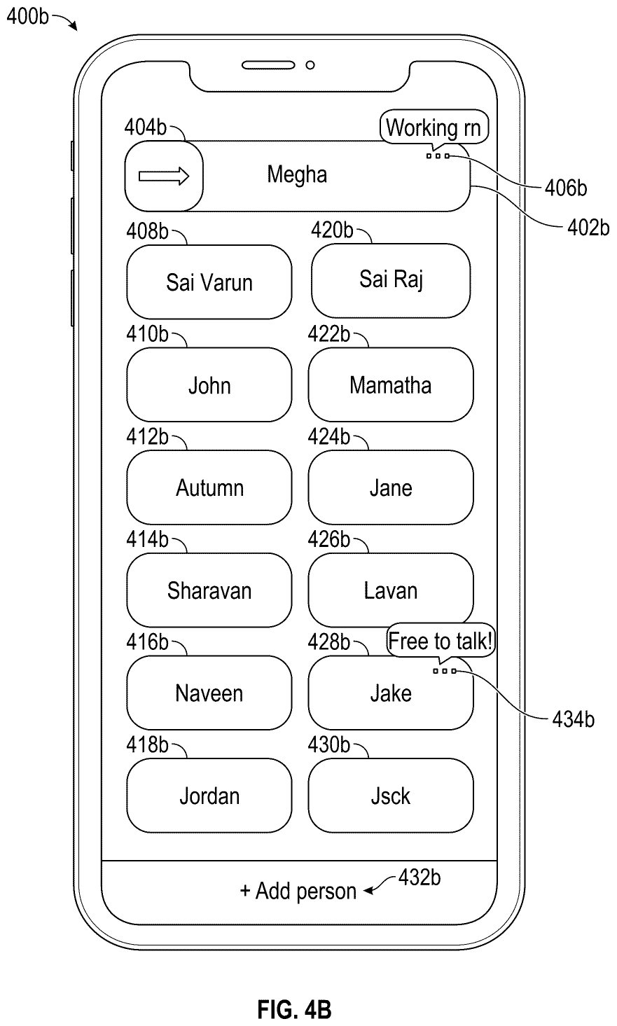

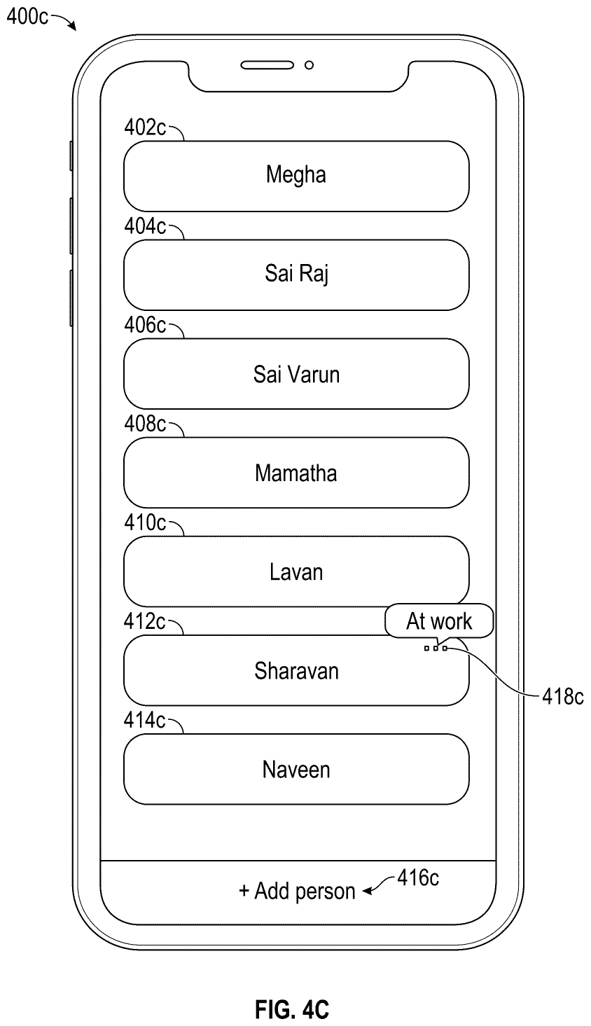

Referring to FIGS. 4A, 4B, and 4C are example screens 400a, 400b, and 400c depicting embodiments of the user interface module, in accordance with one or more exemplary embodiments. The user interface module 208 may include two buttons 402a, and 404a. The button 402a may be a red color button and the button 404a may be a green color button. The buttons 402a, and 404a enable the first user, second user, third user, and Nth user to have control of their communication status by sharing this information selectively with trusted individuals. The tab 402b may display the user's name and the tab 402b may include toggle option 404b. The toggle option 404b enables the users to switch between the red green and purple colors. The tabs 408b, 410b, 412b, 414b, 416b, 418b, 420b, 422b, 424b, 426b, 428b, 430b and 402c, 404c, 406c, 408c, 410c, 414c, 414c may display the friend's names with their selected color. The user interface may include add person option 432b may be configured allow to the user to add new friends.

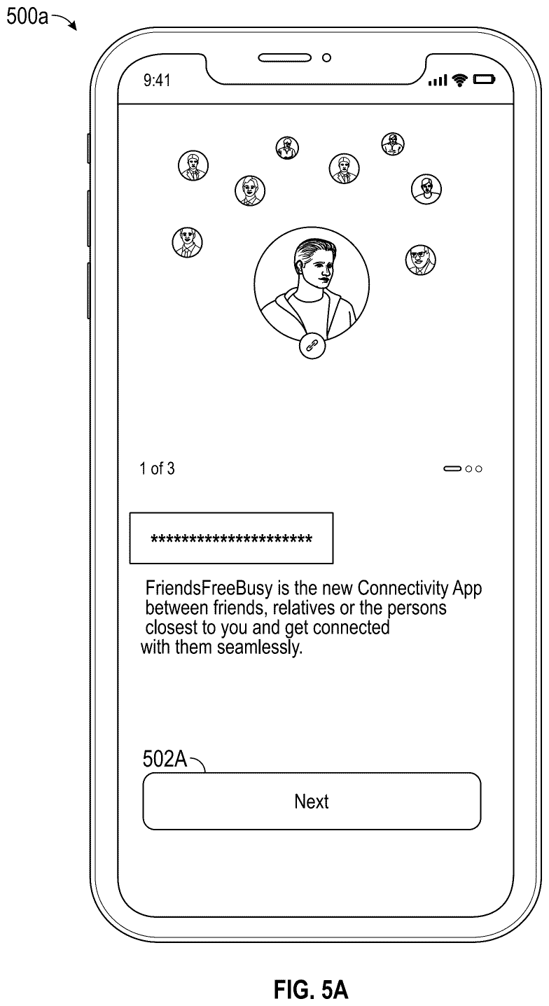

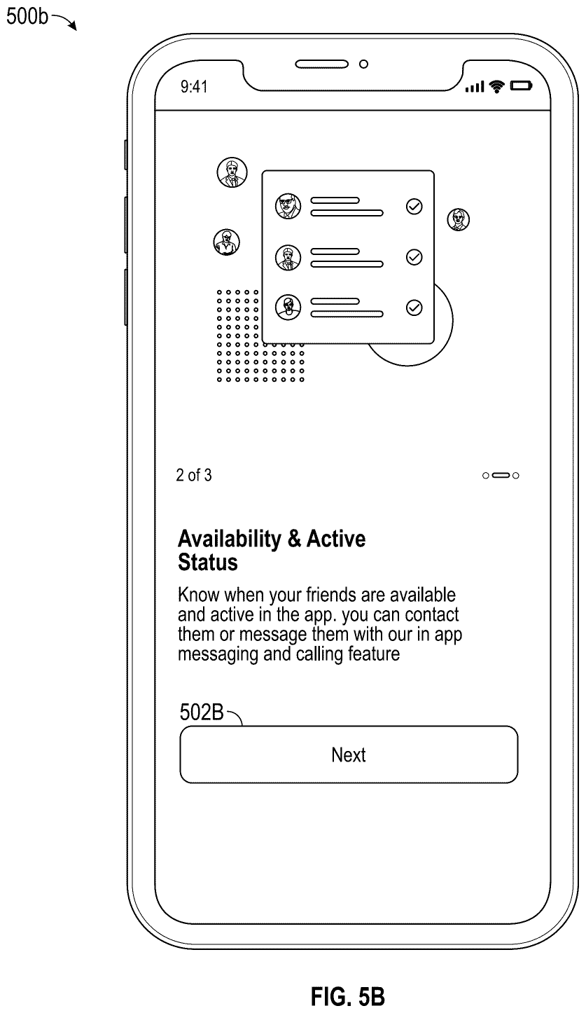

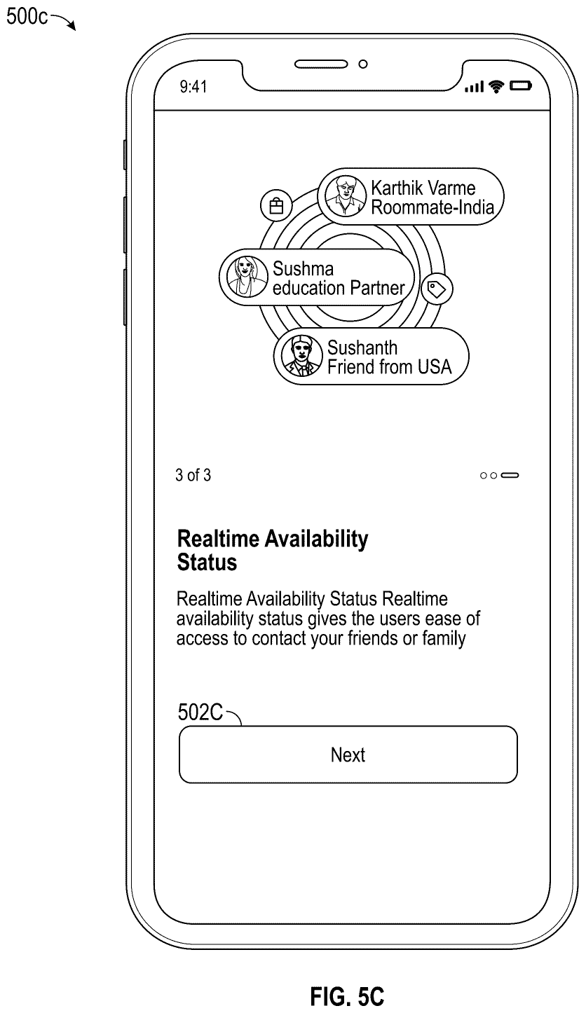

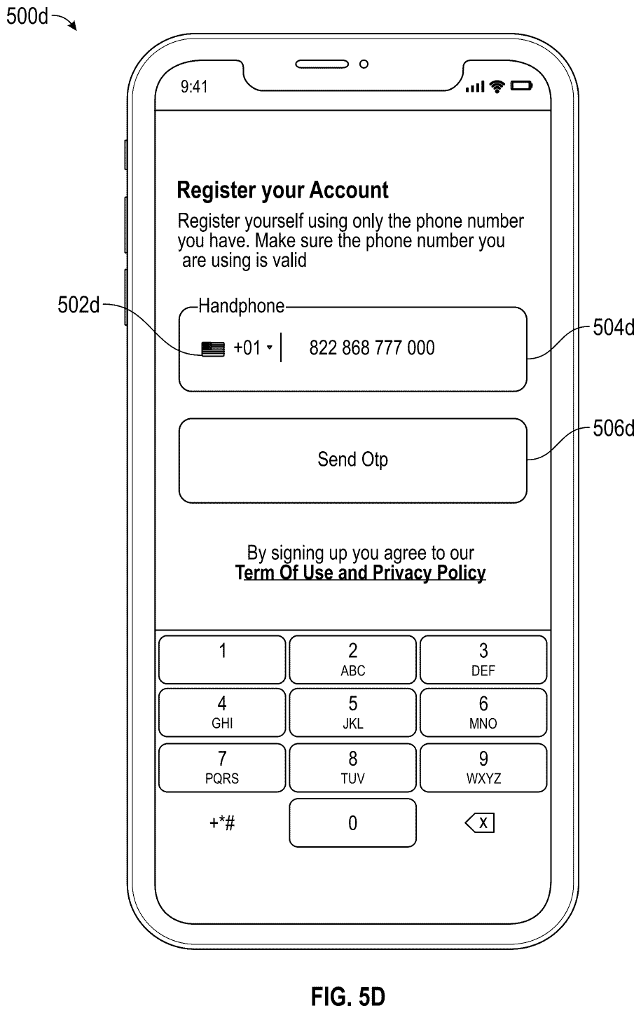

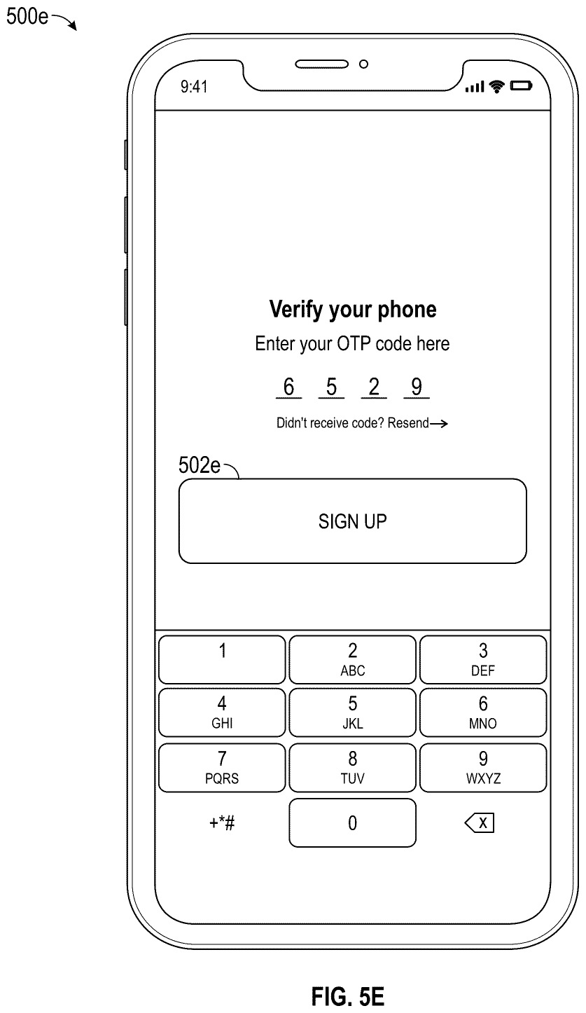

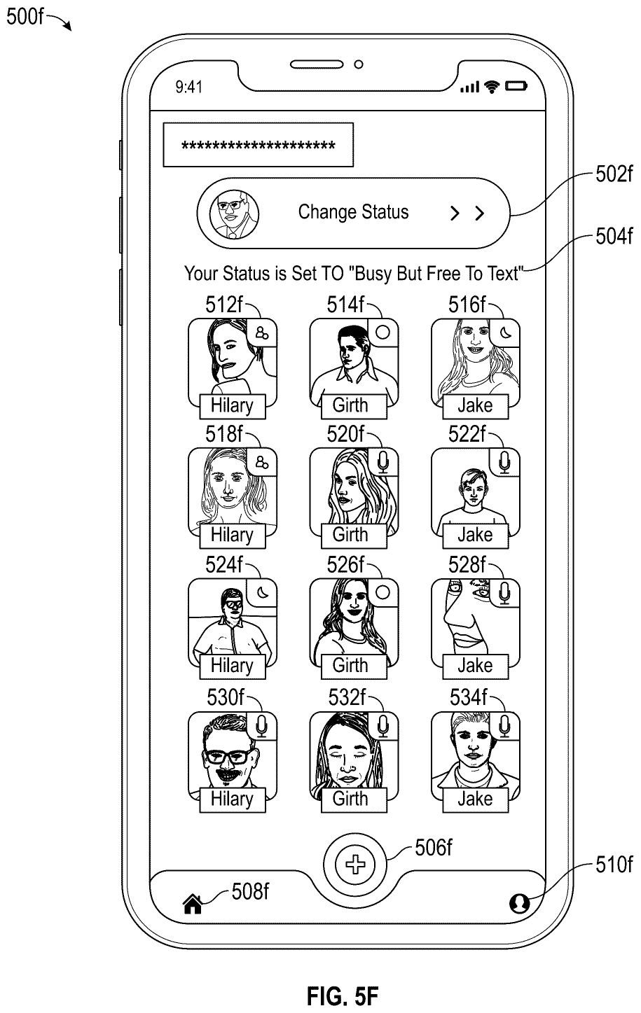

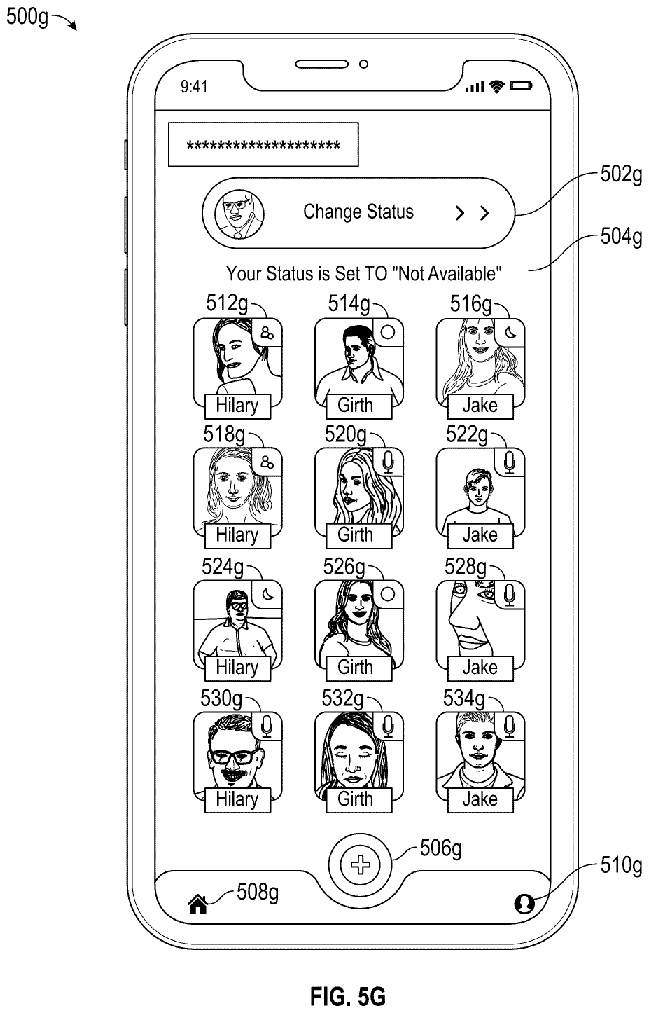

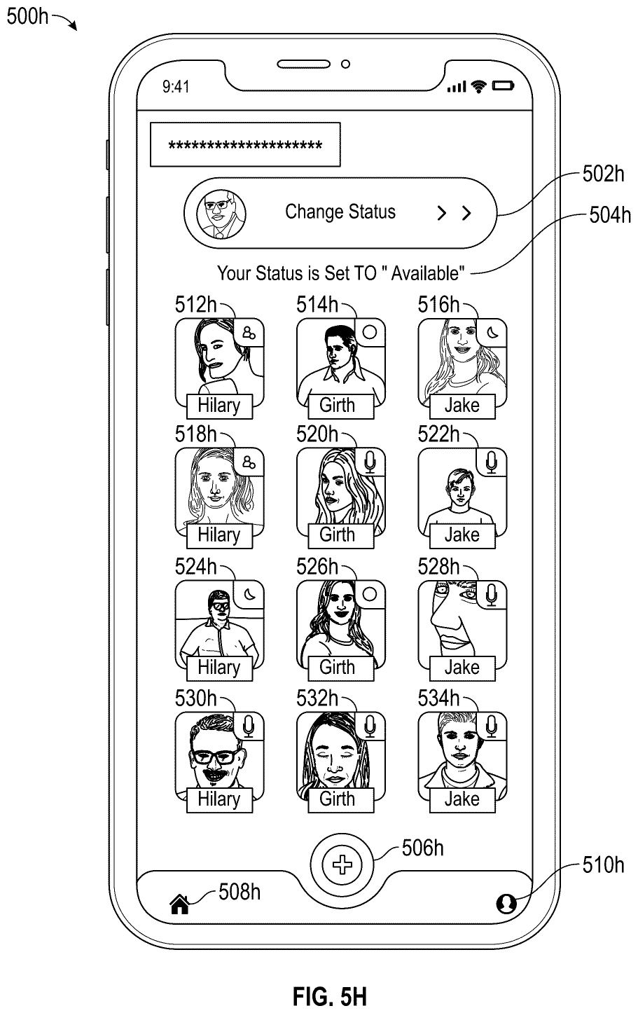

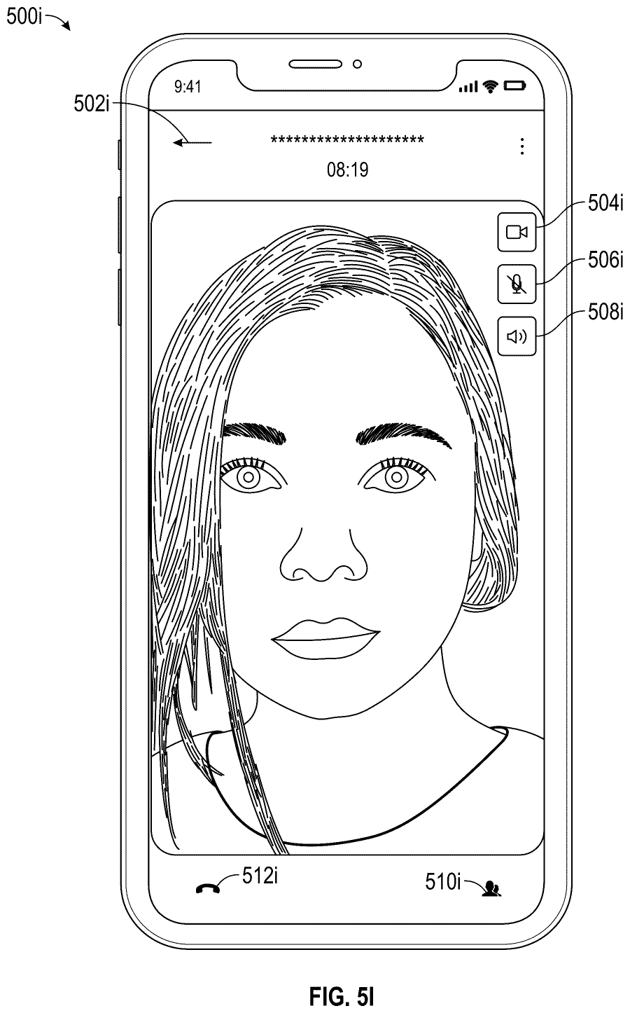

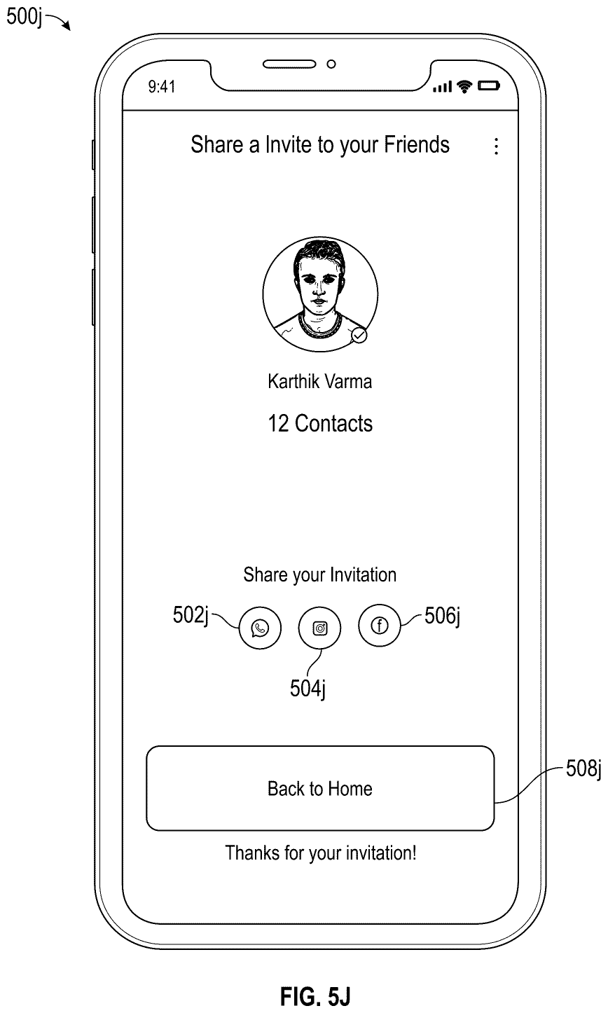

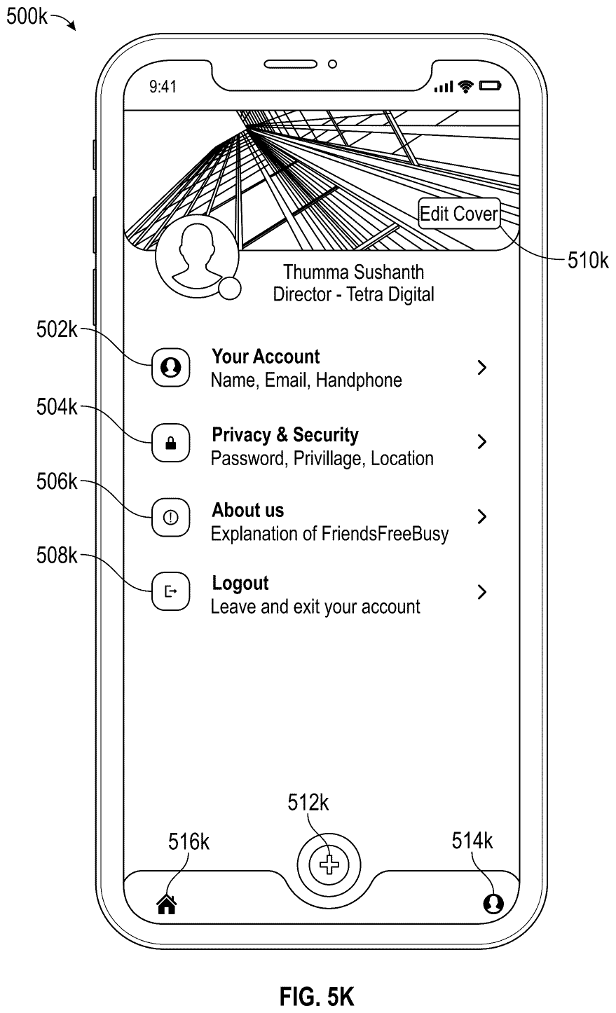

Referring to FIG. 5A is an example screen 500a depicting an interface of the communication status sharing module, showcasing the introduction page for the system, in accordance with one or more exemplary embodiments. The screen highlights the communication status sharing module purpose, providing a welcoming experience to the user, along with a button 502a to navigate to the next step. The user interface module 208 may be configured to display the onboarding screen and render its elements, such as the introductory text, icons representing user connections, and the navigation button 502a. The circular avatar icons at the top visually represent potential connections in the network, providing a sense of personalization and relatability for the user. The “Next” button 502a allows the user to proceed to the next onboarding screen, ensuring a smooth navigation experience. The user profile managing module 206 may retrieve and dynamically load placeholder profiles or suggested connections to display on this screen, aligning with the communication status sharing module 114 objective of fostering close connections. The communication status sharing module 114 presents this screen as the first step in the user journey, aiming to familiarize the user with the purpose of the system while encouraging engagement through intuitive design and navigation. The screen highlights the visual and textual elements required to create a welcoming and engaging experience for the user.

Referring to FIG. 5B is an example screen 500b depicting an interface of the communication status sharing module, showcasing the availability and active status feature of the system, in accordance with one or more exemplary embodiments. The screen highlights how users can view the real-time statuses of their friends and use this information to connect with them through messaging or calling, along with a button 502b to navigate to the next step. The user interface module 208 may be configured to display the onboarding screen and render its elements, such as the descriptive heading (“Availability & Active Status”), explanatory text, visual icons representing friend connections, and the navigation button 502b. The central widget displays example statuses for friends. The statuses may include predefined options such as green for “free to talk,” red for “busy,” and purple for “free to text,” enabling users to make informed decisions about contacting their friends, providing users with a preview of the system's functionality for managing communication. The “Next” button 502b allows users to proceed to the next onboarding screen, ensuring a smooth navigation experience. Pressing this button triggers the system to load the content for the subsequent screen, maintaining an uninterrupted user journey. The communication status sharing module 114 presents this screen as the second step in the user onboarding journey, providing users with an overview of how the system manages availability and active statuses.

Referring to FIG. 5C is an example screen 500c depicting an interface of the communication status sharing module, showcasing the real-time availability status feature of the system, in accordance with one or more exemplary embodiments. The screen highlights how users can view the availability of their friends or family members in real-time, along with relevant details such as names and relationships. The interface also includes a button 502C to navigate to the next step in the onboarding process. The user interface module 208 may be configured to render the graphical elements of the screen, including avatars, names, and relationship descriptions of friends. These visual elements are designed to provide users with an intuitive and personalized experience. The descriptive heading (“Realtime Availability Status”) and supporting text explain how this feature simplifies connecting with friends or family. The central widget graphically represents the user's network, allowing for quick visual identification of the statuses of close connections. The “Next” button 502c provides a clear call-to-action, allowing the user to seamlessly move to the next onboarding step.

Referring to FIG. 5D is an example screen depicting an interface of the communication status sharing module, showcasing the user registration process, in accordance with one or more exemplary embodiments. This screen may guide the user through the initial registration process using their phone number. It ensures secure access to the system through OTP-based authentication. The user interface module 208 may display interactive elements such as the phone number input field 504d, the country code selection dropdown 502d, and the “Send OTP” button 506d. The screen also displays instructional text (“Register your Account”) to guide users on the registration process and a link to the “Terms of Use and Privacy Policy” for compliance purposes. A numeric keypad is integrated into the interface, allowing users to input their phone numbers directly. The user registration module 202 may be configured to process the phone number entered into the input field 504d. Once the user presses the “Send OTP” button 506d, the module transmits the entered phone number to the communication status processing module 116 on the server 112 for verification. The communication status processing module 116 validates the phone number's format and sends an OTP to the user's registered phone number. The user authentication module 204 may handle the subsequent verification of the OTP (in a follow-up screen or workflow). This ensures that only authenticated users gain access to the communication status sharing module, enhancing system security. The user authentication module 204 may provide compliance with privacy and security protocols when handling sensitive user information such as phone numbers. The notifications generating module 306 may be integrated to send an OTP notification to the user's phone. The notifications generating module 306 ensures that the OTP reaches the user promptly, facilitating a smooth registration process. This screen is designed to provide users with a straightforward and secure method to register for the system. By integrating intuitive user interface elements and backend authentication modules, the communication status sharing module ensures a user-friendly and reliable registration experience. The process combines visual clarity, ease of use, and strong security measures to onboard users efficiently.

Referring to FIG. 5E is an example screen depicting an interface of the communication status sharing module, showcasing the phone number verification process using an OTP (One-Time Passcode), in accordance with one or more exemplary embodiments. The user interface module 208 may display this screen, which includes key interactive elements such as an OTP input field, a “SIGN UP” button 502e, and a numeric keypad for entering the OTP. Instructional text (“Verify your phone”) is displayed at the top to guide users, along with a prompt to resend the OTP in case they did not receive it. The “SIGN UP” button 502e allows users to proceed to complete the registration process after successful OTP verification. The user authentication module 204 may handle the OTP verification process. After the user enters the OTP, the module validates it by comparing the entered OTP with the one sent by the communication status processing module 116) on the server 112. If the OTP matches, the user is authenticated, and the registration process is completed. In case of an invalid OTP, the user authentication module 204 may trigger a notification or error message to guide the user to retry the process. The notifications generating module 306 may be configured to send the OTP to the user's phone via SMS during the registration process initiated in the previous screen (FIG. 5D). It also supports the “Resend OTP” functionality by generating and dispatching a new OTP upon user request. The bus 201 facilitates communication between the user interface module, user authentication module, and the backend server. This ensures that the OTP entered by the user is validated promptly and accurately. The seamless exchange of data between these modules enables a smooth and efficient verification process. The communication status sharing module 114 presents this screen as a critical step in the user onboarding journey. By integrating a secure OTP-based verification system, the module ensures that only authorized users gain access. The combination of clear instructions, user-friendly interface elements, and backend support creates a robust and reliable registration workflow.

Referring to FIG. 5F is an example screen 500f depicting an interface of the communication status sharing module, showcasing the user's communication dashboard where friends' statuses are visually represented in accordance with one or more exemplary embodiments. The screen includes interactive elements such as a “Change Status” button 502f, a display of the user's current status 504f, friend avatars 512f-534f, and navigation buttons 508f, 506f, and 510f. This dashboard provides a real-time overview of the user's connections, allowing them to view their friends' communication statuses and interact with them accordingly. The interface is visually engaging, featuring friend avatars color-coded to represent their availability: green for “free to talk,” red for “busy with work,” and purple for “free to text.” The user interface module 208 may display all interactive and visual elements at the top of the screen, the “Change Status” button 502f allows the user to update their own status. Below it, the user's current status is displayed as a message 504f (e.g., “Your Status is Set to: Busy but Free to Text”). This feature provides users with a clear indication of how their availability is communicated to their friends. The friend avatars 512f-534f are organized in a grid layout, with each avatar displaying the friend's profile picture, name, and current status. The status is color-coded: Green indicates that the friend is “free to talk,” signifying their availability for voice communication. Red indicates that the friend is “busy with work,” signifying that they are unavailable for calls. Purple indicates that the friend is “free to text,” signifying availability for text-based communication only. The status checking module 214 dynamically retrieves the real-time statuses of friends from the server 112 through the communication status processing module 116. These statuses are updated in real time to ensure accuracy and consistency across all connected devices. The navigation bar at the bottom of the screen includes three buttons: The home button 508f returns the user to the main dashboard. The add friend button 506f allows users to invite new friends or connections. The profile button 510f redirects the user to their personal profile or account settings. The notifications generating module 306 may trigger notifications to alert the user about changes in their friends' statuses, such as when a friend becomes available or unavailable. This ensures that the user is always aware of the latest updates in their network. The communication status sharing module 114 presents this dashboard as the central hub for managing and interacting with friends. By combining intuitive visual design, real-time functionality, and interactive elements, the system empowers users to make informed decisions about communication based on their friends' availability.

Referring to FIG. 5G, an example screen 500g represents the communication dashboard of the communication status sharing module 114, where the user's current status is set to “Not Available” (red) and the statuses of their friends are visually displayed. The screen includes interactive elements such as the “Change Status” button 502g, the user's status message 504g, friend avatars 512g-534g color-coded for availability, and navigation controls 508g, 506g, and 510g. This dashboard is central to managing real-time communication preferences and understanding friends' availability. The user interface module 208 may display the visual and interactive elements of this screen. The “Change Status” button 502g at the top allows the user to update their own status with a single tap. The current status of the user, displayed below the button as a text message 504g (e.g., “Your Status is Set to: Not Available”), provides immediate feedback on how the user is visible to their friends. The friend avatars 512g-534g are color-coded to indicate the availability of each friend: Green borders indicate that the friend is “free to talk,” signifying their availability for voice communication. Red borders indicate that the friend is “busy with work,” signifying that they are unavailable for calls or messaging. Purple borders indicate that the friend is “free to text,” signifying that they are unavailable for calls but can respond to text communication. Each avatar displays additional visual cues, such as a microphone icon for voice communication, a chat bubble for text messaging, or a crossed-out phone icon for unavailability. The profile managing module (206) dynamically retrieves and displays these avatars, names, and statuses from the user's network, either stored locally in memory 105 or fetched from the server 112. The status checking module 214 ensures that the real-time statuses of friends are retrieved from the server and updated continuously. This module synchronizes with the backend communication status processing module 116 to ensure accuracy across devices. The notifications generating module 306 may generate alerts to notify the user of changes in friends' statuses. For instance, when a friend switches from “busy” to “free to talk,” the dashboard updates in real-time, providing actionable insights for the user. At the bottom of the screen, the navigation bar includes the following: Home button 508g: Returns the user to the main dashboard. Add friend button 506g: Allows the user to invite new connections. Profile button 510g: Redirects the user to their personal profile or settings. The communication status sharing module 114 presents this screen as an interactive and visually intuitive dashboard. By combining color-coded indicators, real-time updates, and accessible navigation controls, the system ensures that users can easily manage their communication preferences and interact with their friends based on their availability.

The screen 500h represents the communication dashboard of the communication status sharing module 114, where the user's current status is set to “Available” (green), and the real-time statuses of their friends are visually displayed. This dashboard is central to managing real-time communication preferences and understanding friends' availability. The user interface module 208 may display all the interactive and visual elements of this screen. The “Change Status” button 502h at the top allows the user to update their own status. Below it, the user's current status is displayed as a text message 504h (e.g., “Your Status is Set To: Available”), providing immediate feedback on how the user is visible to their friends. The friend avatars 512h-534h are displayed in a grid format, with each avatar providing a color-coded indicator for the friend's availability: Green borders signify that the friend is “free to talk,” indicating their availability for voice calls or live communication. Red borders signify that the friend is “busy with work,” indicating they are unavailable for calls or messages. Purple borders signify that the friend is “free to text,” indicating their unavailability for calls but availability for text-based communication. In addition to color-coded borders, each avatar includes relevant visual cues, such as a microphone icon for voice communication, a chat bubble for texting, or a clock icon to indicate unavailability. These cues provide additional clarity about the friend's status and preferred communication method. The profile managing module 206 dynamically retrieves these avatars, names, and statuses from the user's network data, stored in the memory 105 or fetched from the server 112. The status checking module 214 ensures that friends' statuses are updated in real-time. This module communicates with the communication status processing module 116 on the server to synchronize and refresh the displayed information. This ensures that the user always has the latest information regarding their friends' availability. The notifications generating module 306 may send alerts to the user when a friend's status changes. For example, if a friend switches from “busy” to “free to talk,” the dashboard dynamically updates and highlights the change, allowing the user to act on the new information promptly. The navigation bar at the bottom includes the following interactive buttons: home button 508h: Redirects the user to the main dashboard for managing communication. Add friend button 506h: Allows the user to invite or add new connections to their network. Profile button 510h: Takes the user to their personal account settings or profile customization page. The communication status sharing module presents this screen as an interactive, visually intuitive dashboard designed to empower users to manage their communication preferences effectively. By integrating real-time updates, color-coded statuses, and user-friendly navigation, the module ensures that users can interact with their network based on the availability of their connections.

Referring to FIG. 5I is an example screen 500i depicting the interface of the communication status sharing module during an ongoing video call, showcasing options for interacting with the friend, in accordance with one or more exemplary embodiments. The user interface module 208 may be configured to display the layout and interactive elements of the screen. At the top of the interface, the name of the application, communication status sharing module is displayed 502i, along with a timestamp indicating the duration of the ongoing call (e.g., “08:19”). These elements provide clarity to the user regarding the application in use and the call duration. The communication status processing module 116 ensures that the video and audio streams are transmitted seamlessly between the devices. On the right side of the screen, the video toggle button 504i allows the user to enable or disable their video feed during the ongoing call. When the button is toggled, it stops or resumes the video stream being transmitted to the friend. If the user disables the video, a placeholder profile picture or icon is displayed to the friend on the other end. This functionality ensures that users can manage their privacy or adjust their video feed based on their preferences or network conditions. The mute button 506i allows the user to mute their microphone during the call. When activated, it stops transmitting the audio feed to the friend. This functionality is useful for maintaining privacy or minimizing background noise during the call. A muted status indicator may also be displayed on the screen for user confirmation. The speaker button 508i enables or disables the speakerphone functionality. When activated, it toggles the audio output between the device's speaker and earpiece. This feature is helpful when the user wants to switch between private listening and a hands-free experience during the call. The contact list button 510i provides access to the user's contact list of friends who have already been added to their network. When tapped, it displays a list of available friends fetched from the system, allowing the user to invite additional friends to the ongoing call. The button dynamically updates to show the real-time statuses of the listed friends (e.g., free to talk, busy, free to text), ensuring informed selection for multi-party communication. The end call button 512i allows the user to terminate the ongoing call. When activated, it disconnects the video and audio streams and returns the user to the previous screen or the communication dashboard. This functionality ensures a clean and immediate end to the call session.

Referring to FIG. 5J is an example screen depicting the interface of the communication status sharing module, showcasing the option to share an invitation to the user's contacts, in accordance with one or more exemplary embodiments. This screen allows the user to invite their friends or contacts to join the system through multiple sharing options. The screen is designed to provide a seamless way for users to expand their network and foster meaningful connections. At the top, the heading “Share an Invite to your Friends” clearly communicates the purpose of the screen. Below it, the user's avatar and name are displayed, such as “Karthik Varma,” along with the total number of contacts available for invitation (“12 Contacts”). These details are dynamically retrieved and displayed using the profile managing module 206, ensuring that the information is personalized and relevant. The sharing options are represented by three distinct buttons: WhatsApp Button 502j: This button allows the user to share an invitation link through the WhatsApp messaging application. Upon tapping, the system generates a preformatted message containing the invitation link and redirects the user to WhatsApp for immediate sharing. Instagram button 504j: This button enables the user to send the invitation via Instagram. Social Media Button 506j: This button facilitates sharing the invitation on social media platforms such as Facebook, and Twitter. When tapped, the system opens the selected platform with a preformatted post containing the invitation link and description. The navigation button 508j at the bottom is labeled “Back to Home,” providing the user with an option to exit the invitation-sharing interface and return to the home screen. This ensures smooth navigation and a user-friendly experience.

Referring to FIG. 5K is an example screen 500k depicting the interface of the communication status sharing module, showcasing the account management and settings menu, in accordance with one or more exemplary embodiments. This screen allows users to view and manage their personal account details, adjust security and privacy preferences, learn more about the application, and log out of the system. The interface is designed to provide a clear and user-friendly way for users to access and modify key settings. At the top of the screen, the user profile section displays the user's avatar, name, and title (e.g., “Thumma Sushanth, Director-Tetra Digital”). This information is dynamically retrieved using the profile managing module 206 and helps personalize the experience. The “Edit Cover” button 510k allows the user to change the background image of their profile, further enhancing personalization. Upon tapping, this button may prompt the user to upload an image from their device or select a predefined cover. Below the user profile, a list of options is displayed: Your Account 502k, this option provides access to the user's account details, such as name, email, and phone number. When selected, it connects to the user profile managing module 206 to retrieve and display the relevant information. Users can update their details as required, and any changes are securely transmitted to the server via the communication status processing module 116. Privacy & Security 504k, this option allows the user to manage settings related to passwords, permissions, and location data. It ensures that users have full control over their account's security and privacy preferences. Changes made here are processed by the system and synchronized with the server for enhanced security. For example, users may set permissions for location access or enable two-factor authentication. About Us 506k, this option provides information about the application, such as its purpose, features, and benefits. It is designed to help users understand the system and its functionalities. Upon tapping, the user interface module 208 navigates to a screen with detailed explanations of the application's goals and capabilities, fostering user trust and engagement. Logout 508k, this option enables users to log out of their account and exit the application. When selected, it initiates a secure logout process, ensuring that all active sessions are terminated. The communication status processing module 116 communicates with the server to invalidate the user's authentication token, preventing unauthorized access to the account.

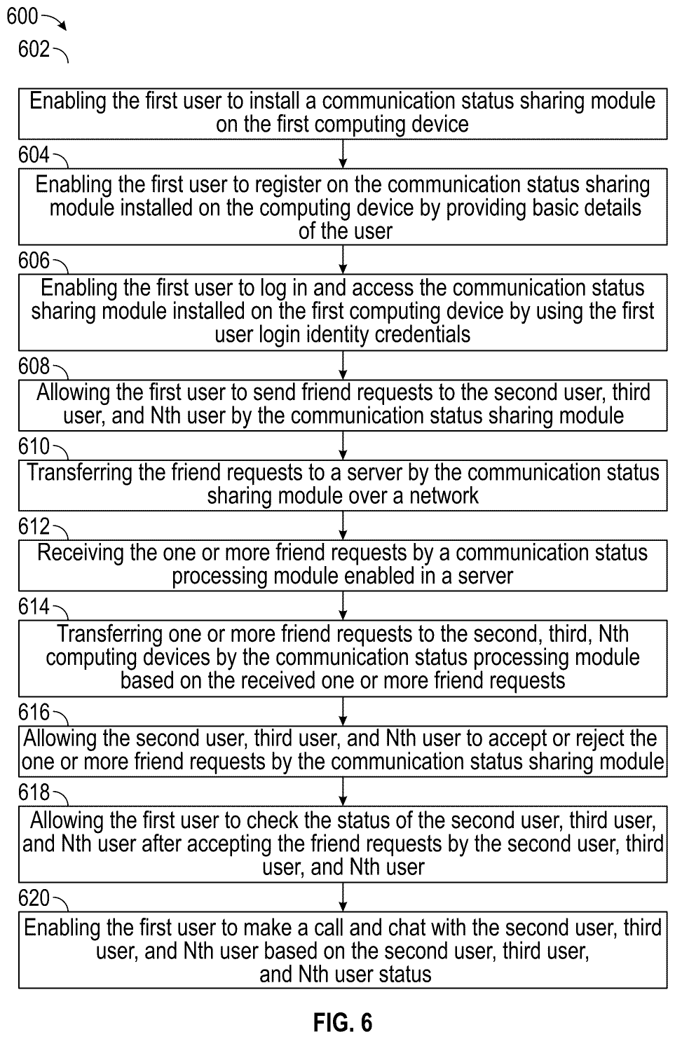

Referring to FIG. 6 is a flow diagram 600 depicting a method for user registration on the communication status sharing module 114, in accordance with one or more exemplary embodiments. The method 600 may be carried out in the context of the details of FIG. 1, FIG. 2, FIG. 3, FIG. 4A, FIG. 4B, FIG. 4C, FIG. 5A, FIG. 5B, FIG. 5C, FIG. 5D, FIG. 5E, FIG. 5F, FIG. 5G, FIG. 5H, FIG. 5I, FIG. 5J, AND FIG. 5K However, the method 600 may also be carried out in any desired environment. Further, the aforementioned definitions may equally apply to the description below.

The method commences at step 602, enabling the first user to install a communication status sharing module on the first computing device. Thereafter at step 604, enabling the first user to register on the communication status sharing module installed on the computing device by providing basic details of the user. Thereafter at step 606, enabling the first user to log in and access the communication status sharing module installed on the first computing device by using the first user login identity credentials. Thereafter at step 608, allowing the first user to send one or more friend requests to the second user, third user, and N^{th} user by the communication status sharing module. Thereafter at step 610, transferring the one or more friend requests to a server by the communication status sharing module over a network. Thereafter at step 612, receiving the one or more friend requests by a communication status processing module enabled in server. Thereafter at step 614, transferring the one or more friend requests to the second, third, and Nth computing devices by the communication status processing module based on the received one or more friend requests. Thereafter at step 616, allowing the second user, third user, and N^{th} user to accept or reject the one or more friend requests by the communication status sharing module. Thereafter at step 618, allowing the first user to check the status of the second user, third user, and Nth user after accepting the friend requests by the second user, third user, and Nth user. Thereafter at step 620, enabling the first user to make a call and chat with the second user, third user, and N^{th} user based on the second user, third user, and N^{th} user status

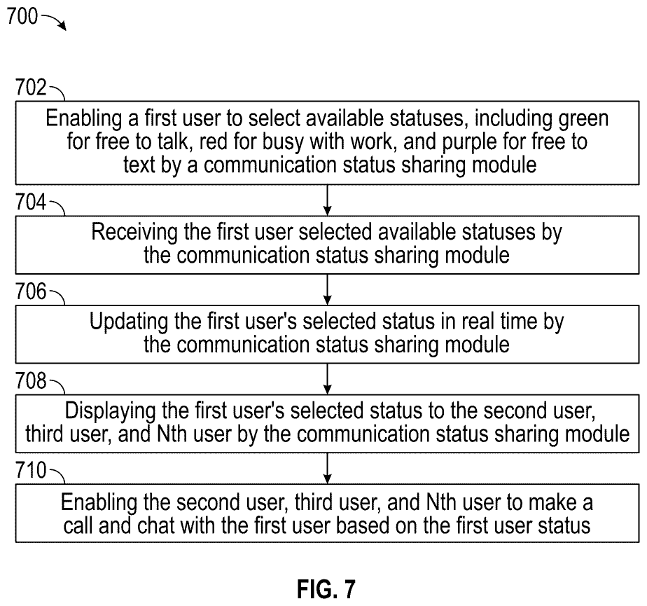

Referring to FIG. 7 is a flow diagram 700 depicting a method for updating user communication status on the communication status sharing module 114, in accordance with one or more exemplary embodiments. The method 600 may be carried out in the context of the details of FIG. 1, FIG. 2, FIG. 3, FIG. 4A, FIG. 4B, FIG. 4C, FIG. 5A, FIG. 5B, FIG. 5C, FIG. 5D, FIG. 5E, FIG. 5F, FIG. 5G, FIG. 5H, FIG. 5I, FIG. 5J, AND FIG. 5K, and FIG. 6 However, the method 700 may also be carried out in any desired environment. Further, the aforementioned definitions may equally apply to the description below.

The method commences at step 702, enabling a first user to select available statuses, including green for free to talk, red for busy with work, and purple for free to text by a communication status sharing module. Thereafter at step 704, receiving the first user selected available statuses through the communication status sharing module. Thereafter at step 706, updating the first user's selected status in real time by the communication status sharing module. Thereafter at step 708, displaying the first user's selected status to the second user, third user, and N^{th} user by the communication status sharing module. Thereafter at step 710, enabling the second user, third user, and Nth user to make a call and chat with the first user based on the first user's status.

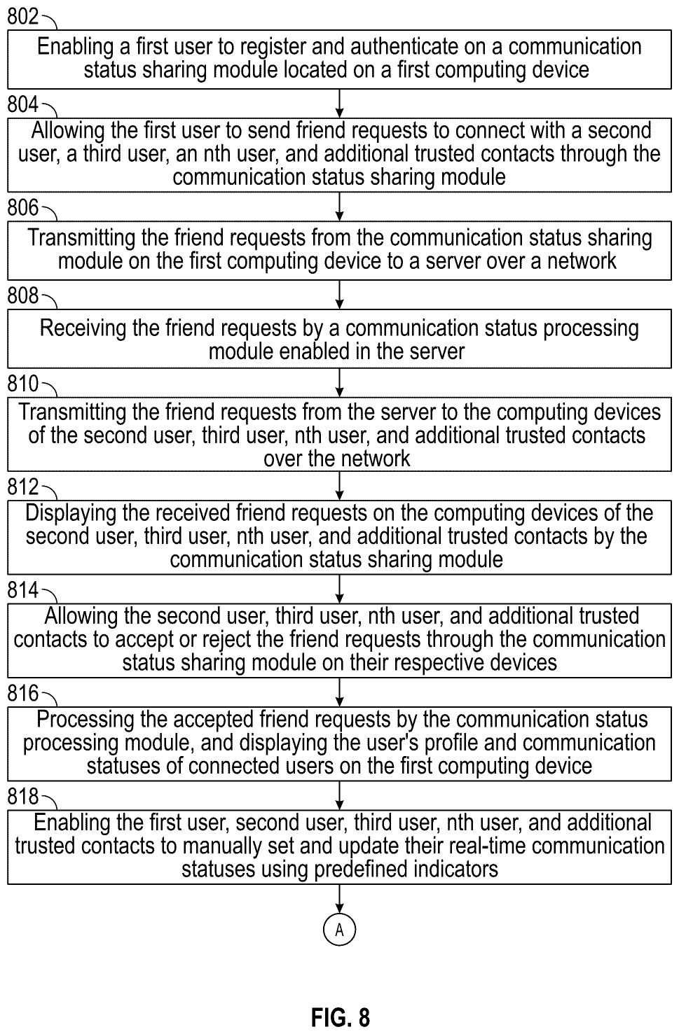

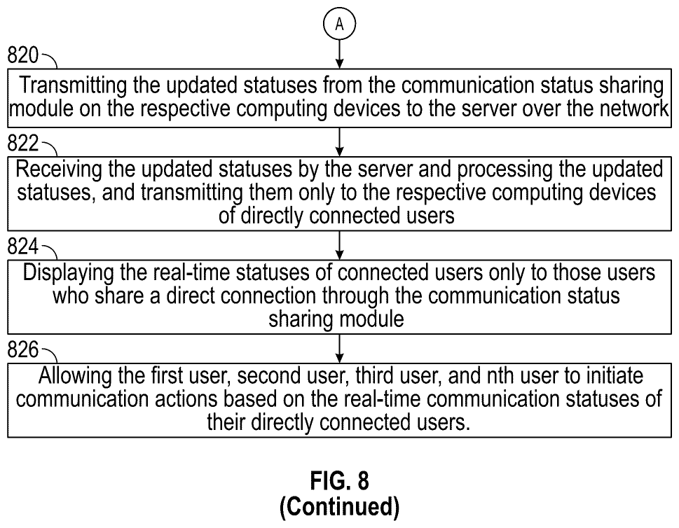

Referring to FIG. 8 is a flow diagram 800 depicting a method for method for sharing user communication statuses with individuals, in accordance with one or more exemplary embodiments. The method commences at step 802, enabling a first user to register and authenticate on a communication status sharing module located on a first computing device. Thereafter at step 804, allowing the first user to send friend requests to connect with a second user, a third user, an nth user, and additional trusted contacts through the communication status sharing module. Thereafter at step 806, transmitting the friend requests from the communication status sharing module on the first computing device to a server over a network. Thereafter at step 808, receiving the friend requests by a communication status processing module enabled in the server. Thereafter at step 810, transmitting the friend requests from the server to the computing devices of the second user, third user, nth user, and additional trusted contacts over the network. Thereafter at step 812, displaying the received friend requests on the computing devices of the second user, third user, nth user, and additional trusted contacts by the communication status sharing module. Thereafter at step 814, allowing the second user, third user, nth user, and additional trusted contacts to accept or reject the friend requests through the communication status sharing module on their respective devices. Thereafter at step 816, processing the accepted friend requests by the communication status processing module, and displaying the user's profile and communication statuses of connected users on the first computing device. Thereafter at step 818, enabling the first user, second user, third user, nth user, and additional trusted contacts to manually set and update their real-time communication statuses using predefined indicators, including green (free to talk), red (busy), and purple (free to text). Thereafter at step 820, transmitting the updated statuses from the communication status sharing module on the respective computing devices to the server over the network. Thereafter at step 822, receiving the updated statuses by the server through the communication status processing module, processing the updated statuses, and transmitting them only to the respective computing devices of directly connected users. Thereafter at step 824, displaying the real-time statuses of connected users only to those users who share a direct connection through the communication status sharing module. Thereafter at step 826, allowing the first user, second user, third user, and nth user to initiate communication actions, including making calls, sending messages, or engaging in in-app chats, based on the real-time communication statuses of their directly connected users.

In accordance with one or more exemplary embodiments of the present disclosure, the processor 103 executes instructions from the communication status sharing module 114, the communication status sharing module 114 may include a user profile managing module 206 may be configured to enable users to create, edit, and manage their profiles, including profile pictures, display names, and linked messaging applications.

In accordance with one or more exemplary embodiments of the present disclosure, the processor 103 executes instructions from the communication status sharing module 114, the communication status sharing module 114 may include the friend management module 210 may be configured to allow users to send, accept, or reject friend requests, and manage a list of trusted contacts for sharing communication statuses.

In accordance with one or more exemplary embodiments of the present disclosure, the processor 103 executes instructions from the communication status sharing module 114, the communication status sharing module 114 may include the status updating module 212 may be configured to enable users to manually set and update their real-time communication statuses using predefined indicators, including green (free to talk), red (busy), and purple (free to text).

In accordance with one or more exemplary embodiments of the present disclosure, the processor 103 executes instructions from the communication status sharing module 114, the communication status sharing module 114 may include the status checking module 214 may be configured to display the real-time statuses of directly connected users, enabling users to view the current availability of their trusted contacts.

In accordance with one or more exemplary embodiments of the present disclosure, the processor 103 executes instructions from the communication status sharing module 114, the communication status sharing module 114 may include the blocking module 216 may be configured to allow users to block specific contacts, changing their visibility and communication permissions.

In accordance with one or more exemplary embodiments of the present disclosure, the blocking module 216 may be configured to enable users to block specific friends, wherein blocking a friend changes the blocked friend's communication status to purple (free to text) for the blocking user, restricting calls while allowing text-based communication.

In accordance with one or more exemplary embodiments of the present disclosure, the server 112 may include the communication status processing module 116, the communication status processing module 116 may include the authentication data processing module 302 may be configured to handle user registration and authentication, validate friend requests, and generate unique identifiers for each user.

In accordance with one or more exemplary embodiments of the present disclosure, the server 112 may include the communication status processing module 116, the communication status processing module 116 may include the automatic status update module 304 may be configured to automatically update a user's status to a default indicator, wherein the default indicator is purple (free to text) when no manual updates are received within a predetermined time.

In accordance with one or more exemplary embodiments of the present disclosure, the server 112 may include the communication status processing module 116, and the communication status processing module 116 may include the notifications generating module 306 may be configured to send notifications to users about status changes, friend requests, or communication attempts.

In accordance with one or more exemplary embodiments of the present disclosure, the server 112 may include the communication status processing module, the communication status processing module 116 may include the warning messages generating module 308 may be configured to generate alerts for users attempting to contact friends whose communication status is marked as red (busy).

In accordance with one or more exemplary embodiments of the present disclosure, the processor 103 executes instructions from the communication status sharing module 114, the communication status sharing module 114 may include the user interface module 208 may be configured to provide a graphical interface for users to view their status, the statuses of connected contacts, and initiate communication actions such as calls, messages, or in-app chats.

In accordance with one or more exemplary embodiments of the present disclosure, the processor 103 executes instructions from the communication status sharing module 114, the communication status sharing module 114 may include the authentication approval module 218 may be configured to manage incoming friend requests and ensure authentication before establishing connections between users.

In accordance with one or more exemplary embodiments of the present disclosure, the communication status sharing module 114 may be configured to integrate with external messaging platforms, enabling users to initiate communication actions through applications such as WhatsApp, Telegram, or Signal, based on the real-time statuses of their connected contacts.

In accordance with one or more exemplary embodiments of the present disclosure, the processor 103 executes instructions from the communication status sharing module 114, the communication status sharing module 114 may include the user interface module 208 may be configured to display a communication dashboard that visually represents the user's current status and the real-time communication statuses of connected friends using color-coded indicators, including green for “free to talk,” red for “busy,” and purple for “free to text.”

In accordance with one or more exemplary embodiments of the present disclosure, the processor 103 executes instructions from the communication status sharing module 114, the communication status sharing module 114 may include the status updating module 212 may be configured to allow the user to update their current communication status by interacting with a “Change Status” button on the communication dashboard.

In accordance with one or more exemplary embodiments of the present disclosure, the server 112 may include the communication status processing module 116, the communication status processing module 116 may include the notifications generating module 306 may be configured to trigger alerts when a friend's communication status changes, such as when a friend becomes available or unavailable for communication.

In accordance with one or more exemplary embodiments of the present disclosure, the processor 103 executes instructions from the communication status sharing module 114, the communication status sharing module 114 may include the user profile managing module 206 may be configured to display friend avatars in a grid layout on the user interface module, each avatar including the friend's profile picture, name, and a color-coded indicator representing their real-time communication status.

In accordance with one or more exemplary embodiments of the present disclosure, the communication status sharing module 114 integrates with other systems and platforms using Application Programming Interfaces (APIs): APIs allow software applications to communicate and interact with each other. They provide a set of functions, protocols, and tools for building connections. APIs can be used for various purposes, such as data sharing, functionality extension, and integration between systems. Web Services: Web services are a type of API that uses standardized web protocols like HTTP and XML/JSON to enable communication between systems over the internet. Examples include RESTful APIs, SOAP (Simple Object Access Protocol) web services, and GraphQL. Message-Oriented Middleware: Middleware systems enable communication between systems by sending messages asynchronously. Examples include message queues, publish-subscribe systems, and event-driven architectures. This approach is useful for decoupling systems and handling high volumes of data. Database Integration: Systems can be connected by sharing a common database or databases. Different systems can read and write data to the same database, allowing for data consistency and shared information. File Transfer: Systems can exchange data by transferring files between them. This approach is useful for batch processing and situations where real-time communication is not necessary. Remote Procedure Calls (RPC): RPC is a protocol that allows one system to call functions or procedures on another system as if they were local. This is often used in distributed computing environments. Direct Network Communication: Systems can communicate directly over a network using various protocols such as TCP/IP or UDP. This approach is common for devices and systems in the same local network. Middleware and Integration Platforms: Middleware and integration platforms provide tools and services for connecting different systems. They often offer pre-built connectors for popular applications and protocols, making integration easier. Cloud-based Integration: Cloud platforms offer services and tools for integrating systems and applications hosted in the cloud. These services can handle various aspects of integration, from data synchronization to process automation. Virtual Private Networks (VPNs): VPNs create secure, encrypted connections between different networks, allowing systems in separate locations to communicate as if they were on the same local network. Direct Hardware Connection: In some cases, systems might be connected directly using hardware interfaces like USB, serial ports, or custom connectors. Custom Protocols and Middleware: Depending on your specific requirements, you might develop custom communication protocols and middleware to enable interaction between your systems. Peer-to-Peer (P2P) Networks: Instead of relying on centralized servers, you can establish peer-to-peer connections between systems. Each system acts as both a client and a server, allowing direct communication between peers. This approach is often used for decentralized applications and file sharing. Blockchain and Distributed Ledgers: Blockchain technology can be used to establish secure and transparent communication between systems. Smart contracts can define communication rules and data-sharing conditions, enabling autonomous interactions. Decentralized Web Protocols: Projects like IPFS (Interplanetary File System) offer a peer-to-peer hypermedia protocol for creating a more decentralized web. Content is addressed by its content, not its location, allowing systems to communicate through distributed networks. Physical Layer Communication: Explore ways to use physical phenomena for communication. For example, you could use variations in light intensity or sound patterns to transmit data between systems equipped with appropriate sensors and receivers. Hobbyist Protocols and Platforms: Some tech enthusiasts experiment with unconventional communication methods for fun or learning. Examples include using amateur radio frequencies, Morse code, or even carrier pigeons equipped with tiny devices for data transfer. Data Hidden in Images or Audio: Hide data within images or audio files using steganography techniques. This method can be used for covert communication, but it requires specialized tools to extract and interpret the hidden data. Game Engines and Virtual Worlds: Use game engines or virtual worlds to create interactive spaces where systems can communicate indirectly through avatars, objects, or virtual environments. Augmented Reality (AR) and Virtual Reality (VR): Leverage AR and VR technologies to create immersive shared spaces where users can communicate, collaborate, and interact with each other and the environment. Quantum Communication: While still in its early stages, quantum communication promises ultra-secure communication between distant systems using quantum entanglement. This approach requires advanced technology and infrastructure. Hackable Hardware: Create custom hardware devices that can communicate by modifying off-the-shelf devices, such as Wi-Fi routers, to establish communication channels not originally intended by the manufacturers. HTTP/HTTPS and RESTful APIs: HTTP (Hypertext Transfer Protocol) and its secure variant HTTPS are widely used for communication over the internet. REST (Representational State Transfer) APIs provide a way to structure URLs and use HTTP methods like GET, POST, PUT, and DELETE to perform actions on resources. WebSocket: WebSocket is a protocol that provides full-duplex communication channels over a single TCP connection. It allows systems to establish a long-lived connection for real-time bidirectional communication. MQTT (Message Queuing Telemetry Transport): MQTT is a lightweight publish-subscribe messaging protocol often used in IoT applications. It's designed for efficient communication and works well in resource-constrained environments. AMQP (Advanced Message Queuing Protocol): AMQP is another messaging protocol that supports message-oriented communication, including message queuing and publish-subscribe patterns. It's used for reliable, asynchronous communication. CoAP (Constrained Application Protocol): CoAP is designed for communication between resource-constrained devices and is often used in IoT contexts. It's similar to HTTP but optimized for low-power and lossy networks. SOAP (Simple Object Access Protocol): SOAP is a protocol for exchanging structured information using XML messages. It's commonly used in enterprise environments for web services communication. RTP (Real-time Transport Protocol) and WebRTC RTP is used for real-time media streaming, often for audio and video. WebRTC (Web Real-Time Communication) builds on RTP to provide browser-based peer-to-peer communication for applications like video conferencing. SMTP/POP/IMAP: These are protocols used for sending and receiving emails. They allow systems to exchange messages and attachments over the internet. FTP (File Transfer Protocol): FTP is used for transferring files between systems. It's commonly used for large file transfers or batch processing. SSH (Secure Shell): SSH provides secure remote access to systems and can also be used for secure file transfer (SFTP) and secure tunneling (SSH tunnel) for other protocols. API Gateways and Integration Platforms: API gateways and integration platforms provide tools to manage, secure, and monitor communication between systems, often abstracting the complexity of underlying protocols. Custom Protocols and Sockets: In some cases, systems might use custom protocols built on top of TCP or UDP sockets to establish communication tailored to their specific needs. HTTP/HTTPS: HTTP (Hypertext Transfer Protocol) and its secure variant HTTPS are foundational protocols for communication over the internet. While not traditionally associated with real-time messaging, they are often used for basic interactions like sending and receiving messages via RESTful APIs. WebSocket: WebSocket is a communication protocol that enables bidirectional, full-duplex communication over a single TCP connection. It is well-suited for real-time messaging applications, enabling low-latency interactions between clients and servers. MQTT (Message Queuing Telemetry Transport): MQTT is a lightweight messaging protocol designed for scenarios with limited bandwidth and unreliable networks. It's often used in Internet of Things (IoT) applications for efficiently sending messages between devices and servers. AMQP (Advanced Message Queuing Protocol): AMQP is a messaging protocol that provides reliable communication between applications. It's commonly used in enterprise environments for tasks like message queuing, publish-subscribe patterns, and more. CoAP (Constrained Application Protocol): CoAP is designed for constrained devices and low-power networks, such as those found in IoT applications. It enables efficient communication for resource-constrained devices. Push Notifications: Technologies like Apple's APNs (Apple Push Notification Service) and Google's FCM (Firebase Cloud Messaging) are used to send push notifications to mobile devices, keeping users informed even when the associated app is not actively running. WebSockets and WebRTC: WebSocket technology, as mentioned earlier, is used for real-time communication. WebRTC (Web Real-Time Communication) is an API for browser-based communication, allowing applications to set up peer-to-peer audio, video, and data channels. Message Brokers: Message brokers like Apache Kafka, RabbitMQ, and NATS facilitate asynchronous communication between different components or services. They ensure reliable message delivery and support various messaging patterns. Email Protocols (SMTP, IMAP, POP): For email messaging, protocols like SMTP (Simple Mail Transfer Protocol), IMAP (Internet Message Access Protocol), and POP (Post Office Protocol) are used to send, receive, and manage email messages. Chat Protocols (XMPP): Extensible Messaging and Presence Protocol (XMPP) is an open standard for instant messaging and presence information. It's commonly used in chat applications to enable real-time messaging. Blockchain and Distributed Ledgers: In some cases, messaging services leverage blockchain or distributed ledger technologies to provide secure and transparent communication. Social Media APIs: Social media platforms offer APIs (e.g., Twitter API, Facebook Graph API) that allow developers to integrate messaging features into their applications.

In accordance with various exemplary embodiments of the present disclosure, the communication status sharing module 114 may be seamlessly integrate with a wide range of messaging and communication platforms. These integrations encompass both general messaging applications like WhatsApp, Facebook Messenger, Telegram, Signal, WeChat, Viber, Line, Kik, Snapchat, and Discord, as well as business and team communication tools including Slack, Microsoft Teams, Google Chat, Asana, Trello, Basecamp, and more. The module extends its compatibility to collaborative tools such as Zoom, Skype for Business, GoToMeeting, BlueJeans, and collaborative whiteboarding solutions like Microsoft Whiteboard and Miro. Additionally, it is designed to integrate with popular email and collaboration suites like Gmail, Outlook, Apple Mail, and more. The module also supports various instant messaging and group chat platforms such as GroupMe, and Rocket. Chat, Zulip, and Mattermost, making it versatile in catering to diverse communication preferences. For enterprise communication, it offers compatibility with Symphony, Workplace by Facebook, Wire, and other enterprise-level platforms. Furthermore, the module extends its reach to IoT and device communication standards, including MQTT, CoAP, XMPP, AMQP, and HTTP/HTTPS APIs for IoT communication. This extensive integration ensures that users can conveniently manage their real-time communication statuses across a wide spectrum of communication tools and platforms.

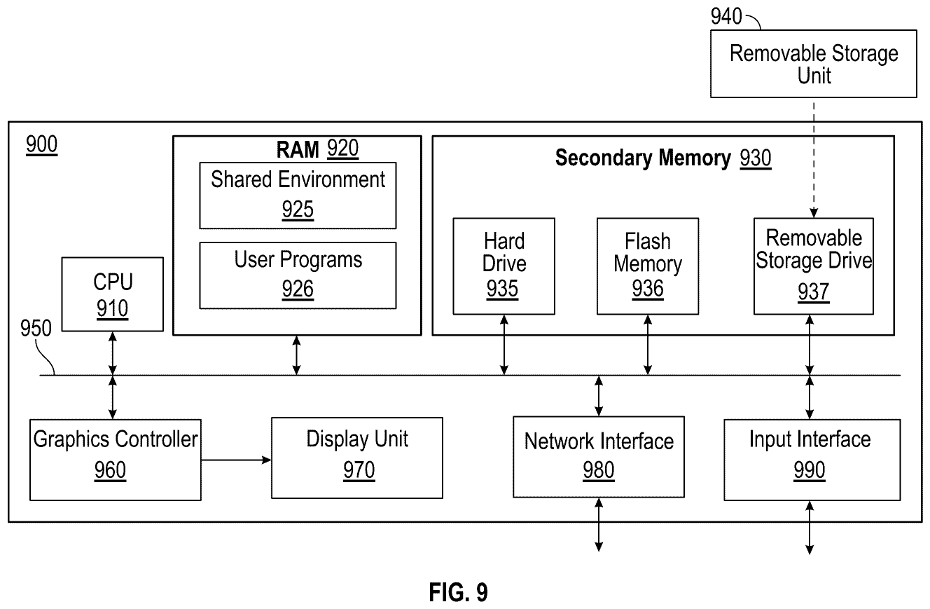

Referring to FIG. 9 is a block diagram 900 illustrating the details of a digital processing system 900 in which various aspects of the present disclosure are operative by execution of appropriate software instructions. The Digital processing system 900 may correspond to the computing devices (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 9720 may receive instructions from secondary memory 930 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touchpad, mouse) and may be used to provide inputs. Network interface 980 provides connectivity to a network (e.g., using Internet Protocol), and may be used to communicate with other systems (such as those shown in FIG. 1) connected to the network.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EEPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

1. A system for sharing user communication statuses with individuals, comprising:
a first computing device comprising a processor for executing instructions from a communication status sharing module located within the computing device, wherein the communication status sharing module is configured to enable a first user to register and authenticate on the communication status sharing module, enabling the first user to send friend requests to connect with a second user, a third user, an nth user, and additional trusted contacts, thereby the communication status sharing module transmitting the friend requests to a server over a network;
the server configured to receive the friend requests from the communication status sharing module and, whereby the server comprises a communication status processing module configured to transmit the friend requests to the computing devices of the second user, third user, nth user, and additional trusted contacts over the network, wherein the computing devices of the second user, third user, nth user, and additional trusted contacts are configured to display the received friend requests through the communication status sharing module and allow the respective users to accept or reject the friend requests, thereby the communication status processing module processes the data and displays the user's profile and communication status of connected users to the first user on the first computing device upon accepting the friend requests;
the communication status sharing module configured to enable the first user, second user, third user, nth user, and additional trusted contacts to manually set and update their real-time communication status using predefined indicators, including green (free to talk), red (busy), and purple (free to text), thereby the communication status sharing module transmitting the first user, second user, third user, nth user, and additional trusted contacts selected statuses to the server over the network;
the communication status processing module configured to receive the communication statuses of the first user, second user, third user, nth user, and additional trusted contacts from the communication status sharing module, thereby the communication status processing module processes the communication statuses and transmits the updated statuses only to the respective computing devices of directly connected users over the network, wherein the communication status sharing module is configured to display the real-time statuses of connected users only to those users who share a direct connection, ensuring that each user can view and interact based on the current availability of their directly connected contacts; and
the communication status sharing module is configured to enable the first user, second user, third user, and nth user to initiate communication actions, including making calls, sending messages, or engaging in in-app chats, based on the real-time communication statuses of their connected users.

2. The system of claim 1, wherein the processor executes instructions from the communication status sharing module, the communication status sharing module comprises a user profile managing module configured to enable users to create, edit, and manage their profiles, including profile pictures, display names, and linked messaging applications.

3. The system of claim 1, wherein the processor executes instructions from the communication status sharing module, the communication status sharing module comprises a friend management module configured to allow users to send, accept, or reject friend requests, and manage a list of trusted contacts for sharing communication statuses.

4. The system of claim 1, wherein the processor executes instructions from the communication status sharing module, the communication status sharing module comprises a status updating module configured to enable users to manually set and update their real-time communication statuses using predefined indicators, including green (free to talk), red (busy), and purple (free to text).

5. The system of claim 1, wherein the processor executes instructions from the communication status sharing module, the communication status sharing module comprises a status checking module configured to display the real-time statuses of directly connected users, enabling users to view the current availability of their trusted contacts.

6. The system of claim 1, wherein the processor executes instructions from the communication status sharing module, the communication status sharing module comprises a blocking module configured to allow users to block specific contacts, changing their visibility and communication permissions.

7. The system of claim 6, wherein the blocking module is configured to enable users to block specific friends, wherein blocking a friend changes the blocked friend's communication status to purple (free to text) for the blocking user, restricting calls while allowing text-based communication.

8. The system of claim 1, wherein the server comprises the communication status processing module, the communication status processing module comprises an authentication data processing module configured to handle user registration and authentication, validate friend requests, and generate unique identifiers for each user.

9. The system of claim 1, wherein the server comprises the communication status processing module, the communication status processing module comprises an automatic status update module configured to automatically update a user's status to a default indicator, wherein the default indicator is purple (free to text) when no manual updates are received within a predetermined time.

10. The system of claim 1, wherein the server comprises the communication status processing module, the communication status processing module comprises a notifications generating module configured to send notifications to users about status changes, friend requests, or communication attempts.

11. The system of claim 1, wherein the server comprises the communication status processing module, the communication status processing module comprises a warning messages generating module configured to generate alerts for users attempting to contact friends whose communication status is marked as red (busy).

12. The system of claim 1, wherein the processor executes instructions from the communication status sharing module, the communication status sharing module comprises a user interface module configured to provide a graphical interface for users to view their status, the statuses of connected contacts, and initiate communication actions such as calls, messages, or in-app chats.

13. The system of claim 1, wherein the processor executes instructions from the communication status sharing module, the communication status sharing module comprises an authentication approval module configured to manage incoming friend requests and ensure authentication before establishing connections between users.

14. The system of claim 1, wherein the communication status sharing module is configured to integrate with external messaging platforms, enabling users to initiate communication actions through applications such as WhatsApp, Telegram, or Signal, based on the real-time statuses of their connected contacts.

15. The system of claim 1, wherein the processor executes instructions from the communication status sharing module, the communication status sharing module comprises the user interface module configured to display a communication dashboard that visually represents the user's current status and the real-time communication statuses of connected friends using color-coded indicators, including green for “free to talk,” red for “busy,” and purple for “free to text.”

16. The system of claim 1, wherein the processor executes instructions from the communication status sharing module, the communication status sharing module comprises a status updating module configured to allow the user to update their current communication status by interacting with a “Change Status” button on the communication dashboard.

17. The system of claim 1, wherein the server comprises the communication status processing module, the communication status processing module comprises the notifications generating module configured to trigger alerts when a friend's communication status changes, such as when a friend becomes available or unavailable for communication.

18. The system of claim 1, wherein the processor executes instructions from the communication status sharing module, the communication status sharing module comprises the user profile managing module configured to display friend avatars in a grid layout on the user interface module, each avatar including the friend's profile picture, name, and a color-coded indicator representing their real-time communication status.

19. A method for sharing user communication statuses with individuals, comprising:
enabling a first user to register and authenticate on a communication status sharing module located on a first computing device;
allowing the first user to send friend requests to connect with a second user, a third user, an nth user, and additional trusted contacts through the communication status sharing module;
transmitting the friend requests from the communication status sharing module on the first computing device to a server over a network;
receiving the friend requests by a communication status processing module enabled in the server;
transmitting the friend requests from the server to the computing devices of the second user, third user, nth user, and additional trusted contacts over the network;
displaying the received friend requests on the computing devices of the second user, third user, nth user, and additional trusted contacts by the communication status sharing module;
allowing the second user, third user, nth user, and additional trusted contacts to accept or reject the friend requests through the communication status sharing module on their respective devices;
processing the accepted friend requests by the communication status processing module, and displaying the user's profile and communication statuses of connected users on the first computing device;
enabling the first user, second user, third user, nth user, and additional trusted contacts to manually set and update their real-time communication statuses using predefined indicators, including green (free to talk), red (busy), and purple (free to text);
transmitting the updated statuses from the communication status sharing module on the respective computing devices to the server over the network;
receiving the updated statuses by the server through the communication status processing module, processing the updated statuses, and transmitting them only to the respective computing devices of directly connected users;
displaying the real-time statuses of connected users only to those users who share a direct connection through the communication status sharing module; and
allowing the first user, second user, third user, and nth user to initiate communication actions, including making calls, sending messages, or engaging in in-app chats, based on the real-time communication statuses of their directly connected users.

20. A computer program product comprising a non-transitory computer-readable medium having a computer-readable program code embodied therein to be executed by one or more processors, said program code including instructions to:
enable a first user to register and authenticate on a communication status sharing module located on a first computing device;
allow the first user to send friend requests to connect with a second user, a third user, an nth user, and additional trusted contacts through the communication status sharing module
transmit the friend requests from the communication status sharing module on the first computing device to a server over a network;
receive the friend requests by a communication status processing module enabled in the server;
transmit the friend requests from the server to the computing devices of the second user, third user, nth user, and additional trusted contacts over the network;
display the received friend requests on the computing devices of the second user, third user, nth user, and additional trusted contacts by the communication status sharing module;
allow the second user, third user, nth user, and additional trusted contacts to accept or reject the friend requests through the communication status sharing module on their respective devices;
process the accepted friend requests by the communication status processing module, and display the user's profile and communication statuses of connected users on the first computing device;
enable the first user, second user, third user, nth user, and additional trusted contacts to manually set and update their real-time communication statuses using predefined indicators, including green (free to talk), red (busy), and purple (free to text);
transmit the updated statuses from the communication status sharing module on the respective computing devices to the server over the network;
receive the updated statuses by the server through the communication status processing module, processing the updated statuses, and transmitting them only to the respective computing devices of directly connected users;
display the real-time statuses of connected users only to those users who share a direct connection through the communication status sharing module; and
allow the first user, second user, third user, and nth user to initiate communication actions, including making calls, sending messages, or engaging in in-app chats, based on the real-time communication statuses of their directly connected users.
